(19) United States
(12) Patent Application Publication
(10) Pub. No.: US 2011/0157138 A1
(43) Pub. Date: Jun. 30, 2011

(54) PLASMA DISPLAY DEVICE AND METHOD OF DRIVING PLASMA DISPLAY PANEL

(75) Inventors: Takahiko Origuchi, Osaka (JP); Hidehiko Shoji, Osaka (JP); Tomoyuki Saito, Osaka (JP)

(73) Assignee: Panasonic Corporation, Osaka (JP)

(21) Appl. No.: 13/061,529

(22) PCT Filed: Jun. 3, 2009
(86) PCT No.: PCT/JP2009/002487

§ 371 Date: Mar. 1, 2011

(30) Foreign Application Priority Data
Sep. 11, 2008 (JP) JP2008-233193
Oct. 9, 2008 (JP) JP2008-262519

(51) Int. Cl. G09G 3/28; G06F 3/038

(52) U.S. Cl. 345/211; 345/68

(57) ABSTRACT

A scan electrode driving circuit performs an address operation by applying a scan pulse to scan electrodes in address periods. The partial light-emitting rate detecting circuit divides the plasma display panel display area into a plurality of regions, and detects a rate of the number of discharge cells to be lit with respect to the number of all the discharge cells in each region, as a partial light-emitting rate, in each subfield. The scan electrode driving circuit performs a first initializing operation in the initializing periods, and a second initializing operation in the address periods. The scan electrode driving circuit performs the address operation on the region having the highest partial light-emitting rate detected in the partial light-emitting rate detecting circuit, immediately after the first initializing operation, and on the region having the second highest partial light-emitting rate immediately after the second initializing operation.

This application is a U.S. National Phase Application of PCT International Application PCT/JP2009/002487.

### TECHNICAL FIELD

The present invention relates to a plasma display device for use in a wall-mounted television or a large monitor and a driving method for a plasma display panel.

### BACKGROUND ART

A typical alternating-current surface discharge panel used as a plasma display panel (hereinafter simply referred to as “panel”) has a large number of discharge cells that are formed between a front plate and a rear plate facing each other. The front plate has the following elements:
a plurality of display electrode pairs, each formed of a scan electrode and a sustain electrode, disposed on a front glass substrate parallel to each other; and
a dielectric layer and a protective layer formed so as to cover the display electrode pairs. The rear plate has the following elements:
a plurality of parallel data electrodes formed on a rear glass substrate;
a dielectric layer formed over the data electrodes so as to cover the data electrodes;
a plurality of barrier ribs formed on the dielectric layer parallel to the data electrodes; and
phosphor layers formed on the surface of the dielectric layer and on the side faces of the barrier ribs.
   The front plate and the rear plate face each other so that the display electrode pairs and the data electrodes three-dimensionally intersect, and are sealed together. A discharge gas containing xenon in a partial pressure ratio of 5%, for example, is sealed into the inside discharge space. Discharge cells are formed in portions where the display electrode pairs face the data electrodes. In a panel having such a structure, gas discharge generates ultraviolet light in each discharge cell. This ultraviolet light excites the red (R), green (G), and blue (G) phosphors so that the phosphors emit the corresponding colors for color display.

A subfield method is typically used as a method for driving the panel. In the subfield method, the brightness is adjusted not by controlling the brightness obtained by one light emission but by controlling the number of light emissions occurring in a unit time (e.g. one field). That is, in the subfield method, one field is divided into a plurality of subfields, and gradations are displayed by causing light emission or no light emission in each discharge cell in each subfield. Each subfield has an initializing period, an address period, and a sustain period.

In the initializing period, an initializing waveform is applied to the respective scan electrodes to cause an initializing discharge in the respective discharge cells. This initializing discharge forms wall charge necessary for the subsequent address operation in the respective discharge cells and generates priming particles (excitation particles for causing an address discharge) for stably causing the address discharge.

In the address period, a scan pulse is sequentially applied to the scan electrodes (hereinafter this operation being also referred to as “scanning”). An address pulse corresponding to the signals of an image to be displayed is selectively applied to the data electrodes (hereinafter, these operations being also generically referred to as “addressing”). Thus, an address discharge is caused between the scan electrodes and the data electrodes in the discharge cells to be lit and forms wall charge therein.

In the sustain period, a sustain pulse is alternately applied to display electrode pairs, each formed of a scan electrode and a sustain electrode, at a predetermined number of times corresponding to a luminance to be displayed. Thereby, a sustain discharge is caused in the discharge cells where the address discharge has formed wall charge, and thus the phosphor layers in the discharge cells are caused to emit light. In this manner, an image is displayed in the image display area of the panel.

In this subfield method, the following operations, for example, can minimize the light emission unrelated to gradation display and thus improve the contrast ratio. In the initializing period of one subfield among a plurality of subfields, an all-cell initializing operation for causing an initializing discharge in all the discharge cells is performed.

In the initializing periods of the other subfields, a selective initializing operation for causing an initializing discharge selectively in the discharge cells having undergone a sustain discharge is performed. With the recent increase in the screen size and luminance of a panel, the power consumption of the panel tends to increase. In a panel of large screen and high definition, an increase in the load during driving of the panel tends to destabilize the discharge. In order to cause a stable discharge, the driving voltage to be applied to the electrodes is increased. This is one of the causes of further increasing the power consumption. Further, when the driving voltage or power consumption increases and exceeds the rated values of the components constituting the driving circuits, the circuits can malfunction.

For example, a data electrode driving circuit performs an address operation for applying an address pulse voltage to the data electrodes and causing an address discharge in the discharge cells. When the power consumption during addressing exceeds the rated values of the integrated circuits (ICs) constituting the data electrode driving circuit, the ICs can malfunction and cause an addressing failure, e.g. occurrence of no address discharge in the discharge cells where an address discharge is to be caused, or occurrence of an address discharge in the discharge cells where no address discharge is to be caused. Thus, in order to suppress the power consumption during addressing, a method (e.g. Patent Literature 1) is disclosed. In this method, the power consumption of the data electrode driving circuit is estimated according to the signals of an image to be displayed, and when the estimated value is equal to or higher than a set value, gradations are limited.

As described above, in the address period, an address discharge is caused by applying a scan pulse voltage to the scan electrodes and an address pulse voltage to the data electrodes. For this reason, it is difficult to cause a stable address operation only with the technique for stabilizing the operation of the data electrode driving circuit disclosed in Patent Literature 1. A technique for stabilizing the operation of a circuit for driving the scan electrodes (scan electrode driving circuit) is also important.

Further, the scan pulse voltage is sequentially applied to the respective scan electrodes in the address period. Thus, especially in a high-definition panel, an increased number of scan electrodes increase the time required for the address period. For this reason, the loss of the wall charge in the discharge cells undergoing an address operation in a later part of the address period is larger than the loss of the wall charge in the discharge cells undergoing an address operation in an earlier part of the address period. Thus, the address discharge in the former cells tends to be unstable.

### CITATION LIST

### Patent Literature

[PTL1] Japanese Patent Unexamined Publication No. 2000-66638

### SUMMARY OF INVENTION

A plasma display device includes the following elements:
a panel,
   the panel being driven by a subfield method in which a plurality of subfields are set in one field, each of the subfields has an initializing period, an address period, and a sustain period, a luminance weight is set for each subfield, and sustain pulses corresponding in number to the luminance weight are generated in the sustain period for gradation display,
   the panel having a plurality of discharge cells, the discharge cells having display electrode pairs, each of the display electrode pairs being formed of a scan electrode and a sustain electrode;
a scan electrode driving circuit for performing an address operation by applying a scan pulse to the scan electrodes in the address period; and
a partial light-emitting rate detecting circuit for dividing a display area of the panel into a plurality of regions, and for detecting a rate of the number of discharge cells to be lit with respect to the number of all the discharge cells in each of the regions, as a partial light-emitting rate, in each subfield.
   The scan electrode driving circuit performs a first initializing operation in the initializing period, and performs a second initializing operation in the address period. The scan electrode driving circuit performs the address operation on the region having the highest partial light-emitting rate detected in the partial light-emitting rate detecting circuit, immediately after the first initializing operation, and performs the address operation on the region having the second highest partial light-emitting rate immediately after the second initializing operation.

Performing such a plurality of initializing operations can increase the number of regions where the lapse of time from the initializing operation to the address operation can be shortened, and allows the address operation on the regions having the higher light-emitting rates in the shorter lapse of time from the initializing operation to the address operation. Thus, even in a panel of large screen and high definition, this structure can cause a stable address discharge by preventing an increase in the scan pulse voltage (amplitude) necessary for causing a stable address discharge. As a result, the image display quality of the panel can be enhanced.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel.

FIG. 3 is a waveform chart of driving voltages applied to the respective electrodes of the panel.

FIG. 4 is a circuit block diagram of a plasma display device in accordance with the first exemplary embodiment.

FIG. 5 is a circuit diagram showing a structure of a scan electrode driving circuit of the plasma display device.

FIG. 6 is a schematic diagram showing an example of the connection between regions for detecting partial light-emitting rates and scan integrated circuits (ICs) in accordance with the first exemplary embodiment.

FIG. 7 is a schematic diagram showing an example of the order of address operations of the scan ICs in accordance with the first exemplary embodiment.

FIG. 8 is a characteristics chart showing the relation between the order of address operations of the scan ICs and a scan pulse voltage (amplitude) necessary for causing a stable address discharge in accordance with the first exemplary embodiment.

FIG. 9 is a characteristics chart showing the relation between a partial light-emitting rate and a scan pulse voltage (amplitude) necessary for causing a stable address discharge in accordance with the first exemplary embodiment.

FIG. 10 is a circuit block diagram showing a configuration example of a scan IC switching circuit in accordance with the first exemplary embodiment.

FIG. 11 is a circuit diagram showing a configuration example of SID generating circuits in accordance with the first exemplary embodiment.

FIG. 12 is a timing chart for explaining an operation of the scan IC switching circuit in accordance with the first exemplary embodiment.

FIG. 13 is a circuit diagram showing another configuration example of the scan IC switching circuit in accordance with the first exemplary embodiment.

FIG. 14 is a timing chart for explaining another example of the scan IC switching operation in accordance with the first exemplary embodiment.

FIG. 15 is a diagram schematically showing a light emission state in a low subfield when a predetermined image is displayed by address operations in an order based on partial light-emitting rates.

FIG. 16 is a diagram schematically showing a light emission state in a low subfield when an image similar to the display image of FIG. 15 is displayed by a sequential address operation from the scan electrode at the top end of the panel toward the scan electrode at the bottom end of the panel.

FIG. 17 is a circuit block diagram of a plasma display device in accordance with a second exemplary embodiment of the present invention.

FIG. 18 is a waveform chart of driving voltages applied to the respective electrodes of a panel in accordance with a third exemplary embodiment of the present invention.

FIG. 19 is a diagram schematically showing the relation between a scan pulse voltage (amplitude) necessary for causing a stable address discharge and an order of address operations, and driving voltage waveforms applied to scan electrode SC1 through scan electrode SCn in two-phase driving in accordance with the third exemplary embodiment.

FIG. 20 is a schematic diagram showing an example of a scanning order (an example of order of address operations of scan ICs) based on partial light-emitting rates when a predetermined image is displayed by the two-phase driving in accordance with the third exemplary embodiment.

FIG. 21 is a circuit diagram of a scan electrode driving circuit in accordance with the third exemplary embodiment.

FIG. 22 is a chart for explaining the correlation between control signal OC1′ and control signal OC2 and the operation state of a scan IC in accordance with the third exemplary embodiment.

FIG. 23 is a timing chart for explaining an example of the operation of the scan electrode driving circuit in accordance with the third exemplary embodiment.

### DESCRIPTION OF EMBODIMENTS

Hereinafter, a plasma display device in accordance with exemplary embodiments of the present invention will be described, with reference to the accompanying drawings.

### Example 1

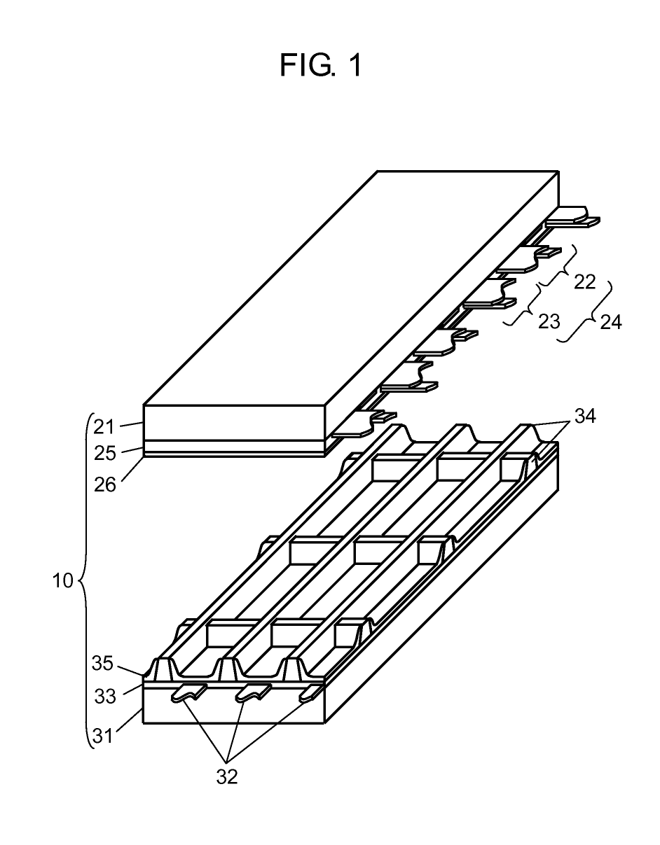

FIG. 1 is an exploded perspective view showing a structure of panel 10 in accordance with the first exemplary embodiment of the present invention. A plurality of display electrode pairs 24, each formed of scan electrode 22 and sustain electrode 23, are disposed on glass front plate 21. Dielectric layer 25 is formed so as to cover scan electrodes 22 and sustain electrodes 23. Protective layer 26 is formed over dielectric layer 25.

In order to lower a breakdown voltage in discharge cells, protective layer 26 is made of a material predominantly composed of MgO because MgO has proven performance as a panel material, and exhibits a large secondary electron emission coefficient and excellent durability when neon (Ne) and xenon (Xe) gas is sealed.

A plurality of data electrodes 32 are formed on rear plate 31. Dielectric layer 33 is formed so as to cover data electrodes 32, and mesh barrier ribs 34 are formed on the dielectric layer 33. On the side faces of barrier ribs 34 and on dielectric layer 33, phosphor layers 35 for emitting light of red (R), green (G), and blue (B) colors are formed.

Front plate 21 and rear plate 31 face each other so that display electrode pairs 24 intersect with data electrodes 32 with a small discharge space sandwiched between the electrodes. The outer peripheries of the plates are sealed with a sealing material, e.g. a glass frit. In the inside discharge space, a mixed gas of neon and xenon is charged as a discharge gas. In this exemplary embodiment, a discharge gas having a xenon partial pressure of approximately 10% is used to improve the emission efficiency. The discharge space is partitioned into a plurality of compartments by barrier ribs 34. Discharge cells are formed in intersecting parts of display electrode pairs 24 and data electrodes 32. The discharge cells discharge and emit light to display an image.

The structure of panel 10 is not limited to the above, and may include barrier ribs formed in a stripe pattern. The mixing ratio of the discharge gas is not limited to the above value, and other mixing ratios may be used.

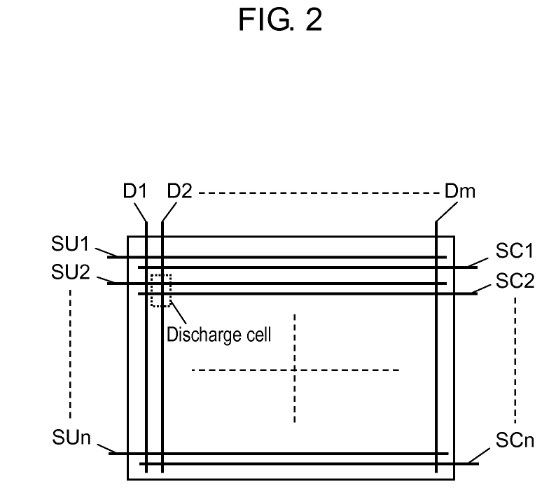

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both long in the row direction, and m data electrode D1 through data electrode Dm (data electrodes 32 in FIG. 1) long in the column direction. A discharge cell is formed in the part where a pair of scan electrode SCi (i being 1 through n) and sustain electrode SUi intersects with one data electrode Dj (j being 1 through m). Thus, m×n discharge cells are formed in the discharge space. The area where m×n discharge cells are formed is the display area of panel 10.

Next, driving voltage waveforms for driving panel 10 and the operation thereof are outlined. A plasma display device of this exemplary embodiment display gradations by a subfield method: one field is divided into a plurality of subfields along a temporal axis, a luminance weight is set for each subfield, and light emission and no light emission of each discharge cell is controlled in each subfield.

In this subfield (SF) method, one field is formed of eight subfields (the first SF, and the second SF through the eighth SF), and the respective subfields have luminance weights of 1, 2, 4, 8, 16, 32, 64, and 128, for example. In the initializing period of one subfield among the plurality of subfields, an all-cell initializing operation for causing an initializing discharge in all the discharge cells is performed (hereinafter, a subfield for the all-cell initializing operation being referred to as “all-cell initializing subfield”). In the initializing periods of the other subfields, a selective initializing operation for causing an initializing discharge selectively in the discharge cells having undergone a sustain discharge is performed (hereinafter, a subfield for the selective initializing operation being referred to as “selective initializing subfield”). These operations can minimize the light emission unrelated to gradation display and improve the contrast ratio.

In this exemplary embodiment, in the initializing period of the first SF, the all-cell initializing operation is performed. In the initializing periods of the second SF through the eighth SF, the selective initializing operation is performed. With these operations, the light emission unrelated to image display is only the light emission caused by the discharge in the all-cell initializing operation in the first SF. The luminance of a black level, i.e. the luminance of an area displaying a black picture where no sustain discharge is caused, is determined only by the weak light emission in the all-cell initializing operation. Thus, an image having a high contrast can be displayed. In the sustain period of each subfield, sustain pulses equal in number to the luminance weight of the subfield multiplied by a predetermined proportionality factor are applied to respective display electrode pairs 24. The proportionality factor at this time is a luminance magnification.

However, in this exemplary embodiment, the number of subfields, or the luminance weight of each subfield is not limited to the above values. The subfield structure may be switched according to image signals, for example.

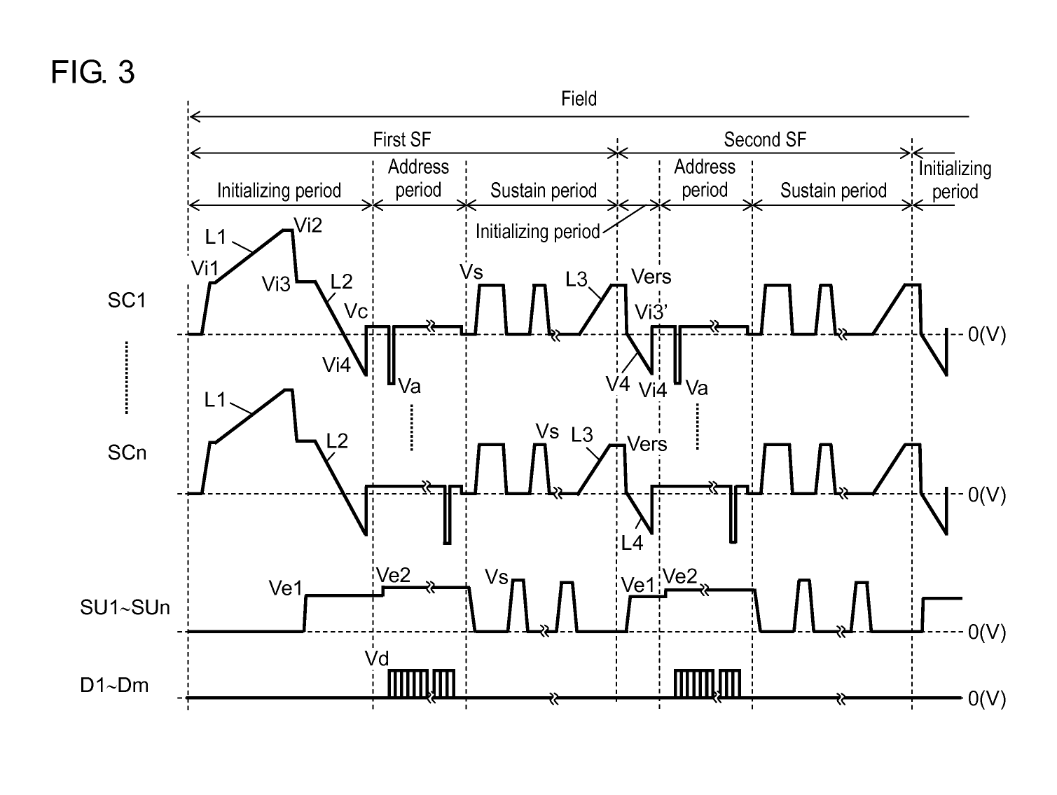

FIG. 3 is a waveform chart of driving voltages applied to the respective electrodes of panel 10 in accordance with the first exemplary embodiment. FIG. 3 shows driving waveforms applied to scan electrode SC1 undergoing an address operation first in the address periods, scan electrode SCn undergoing the address operation last in the address periods, sustain electrode SU1 through sustain electrode SUn, and data electrode D1 through data electrode Dm.

FIG. 3 shows driving voltage waveforms in two subfields: the first subfield (first SF), i.e. an all-cell initializing subfield; and the second subfield (second SF), i.e. a selective initializing subfield. The driving voltage waveforms in the other subfields are substantially similar to driving voltage waveforms in the second SF, except for the numbers of sustain pulses generated in the sustain periods. Scan electrode SCi, sustain electrode SUi, and data electrode Dk to be described below show the electrodes selected from the corresponding electrodes, according to image data (data showing light emission and no light emission in each subfield).

First, a description is provided for the first SF, an all-cell initializing subfield.

In the first half of the initializing period of the first SF, 0(V) is applied to each of data electrode D1 through data electrode Dm and sustain electrode SU1 through sustain electrode SUn, and rising ramp voltage (hereinafter, referred to as “up-ramp voltage”) L1 is applied to scan electrode SC1 through scan electrode SCn. Here, the up-ramp voltage gradually (e.g. at a gradient of approximately 1.3 V/μsec) rises from voltage Vi1, which is equal to or lower than a breakdown voltage, toward voltage Vi2, which exceeds the breakdown voltage, with respect to sustain electrode SU1 through sustain electrode SUn.

While up-ramp voltage L1 is rising, a weak initializing discharge continuously occurs between scan electrode SC1 through scan electrode SCn and sustain electrode SU1 through sustain electrode SUn, and between scan electrode SC1 through scan electrode SCn and data electrode D1 through data electrode Dm. Then, negative wall voltage accumulates on scan electrode SC1 through scan electrode SCn; positive wall voltage accumulates on data electrode D1 through data electrode Dm and sustain electrode SU1 through sustain electrode SUn. Here, this wall voltage on the electrodes means the voltage generated by the wall charge that is accumulated on the dielectric layers covering the electrodes, the protective layer, the phosphor layers, or the like.

In the second half of the initializing period, positive voltage Ve1 is applied to sustain electrode SU1 through sustain electrode SUn, 0(V) is applied to data electrode D1 through data electrode Dm, and falling ramp voltage (hereinafter referred to as “down-ramp voltage”) L2 is applied to scan electrode SC1 through scan electrode SCn. Here, the down-ramp voltage gradually falls from voltage Vi3, which is equal to or lower than the breakdown voltage, toward voltage Vi4, which exceeds the breakdown voltage, with respect to sustain electrode SU1 through sustain electrode SUn.

During this application, a weak initializing discharge occurs between scan electrode SC1 through scan electrode SCn and sustain electrode SU1 through sustain electrode SUn, and between scan electrode SC1 through scan electrode SCn and data electrode D1 through data electrode Dm. This weak discharge reduces the negative wall voltage on scan electrode SC1 through scan electrode SCn, and the positive wall voltage on sustain electrode SU1 through sustain electrode SUn, and adjusts the positive wall voltage on data electrode D1 through data electrode Dm to a value appropriate for the address operation. In this manner, the all-cell initializing operation for causing an initializing discharge in all the discharge cells is completed.

As shown in the initializing period of the second SF in FIG. 3, driving voltage waveforms where the first half of the initializing period is omitted may be applied to the respective electrodes. That is, voltage Ve1 is applied to sustain electrode SU1 through sustain electrode SUn, 0 (V) is applied to data electrode D1 through data electrode Dm, and down-ramp voltage L4 is applied to scan electrode SC1 through scan electrode SCn. Here, down-ramp voltage L4 gradually falls from a voltage equal to or lower than the breakdown voltage (e.g. a ground potential) toward voltage Vi4. This application causes a weak initializing discharge in the discharge cells having undergone a sustain discharge in the sustain period of the immediately preceding subfield (the first SF in FIG. 3), and reduces the wall voltage on scan electrode SCi and sustain electrode SUi. The excess part of the wall voltage on data electrode Dk (k being 1 through m) is discharged, and the wall voltage is adjusted to a value appropriate for the address operation. On the other hand, in the discharge cells having undergone no sustain discharge in the immediately preceding subfield, no discharge occurs, and the wall charge at the completion of the initializing period of the immediately preceding subfield is maintained. In this manner, the initializing operation where the first half is omitted is a selective initializing operation for causing an initializing discharge in the discharge cells having undergone a sustain operation in the sustain period of the immediately preceding subfield.

In the subsequent address period, scan pulse voltage Va is sequentially applied to scan electrode SC1 through scan electrode SCn. Positive address pulse voltage Vd is applied to data electrode Dk (k being 1 through m) corresponding to a discharge cell to be lit among data electrode D1 through data electrode Dm. Thus, an address discharge is caused selectively in the corresponding discharge cells. At this time, in this exemplary embodiment, according to the detection result in the partial light-emitting rate detecting circuit to be described later, the order of scan electrodes 22 to be applied with scan pulse voltage Va, or the order of the address operations of the ICs for driving scan electrodes 22 is changed. The details will be described later. Herein, a description is provided for a case where scan pulse voltage Va is sequentially applied from scan electrode SC1.

In the address period, first, voltage Ve2 is applied to sustain electrode SU1 through sustain electrode SUn, and voltage Vc is applied to scan electrode SC1 through scan electrode SCn.

Next, negative scan pulse voltage Va is applied to scan electrode SC1 in the first row, and positive address pulse voltage Vd is applied to data electrode Dk (k being 1 through m) of the discharge cell to be lit in the first row among data electrode D1 through data electrode Dm. At this time, the voltage difference in the intersecting part of data electrode Dk and scan electrode SC1 is obtained by adding the difference between the wall voltage on data electrode Dk and the wall voltage on scan electrode SC1 to the difference in an externally applied voltage (voltage Vd−voltage Va), and thus exceeds the breakdown voltage. Then, a discharge occurs between data electrodes Dk and scan electrode SC1. Since voltage Ve2 is applied to sustain electrode SU1 through sustain electrode SUn, the voltage difference between sustain electrode SU1 and scan electrode SC1 is obtained by adding the difference between the wall voltage on sustain electrode SU1 and the wall voltage on scan electrode SC1 to the difference in an externally applied voltage (voltage Ve2−voltage Va). At this time, setting voltage Ve2 to a value slightly lower than the breakdown voltage can make a state where a discharge is likely to occur but not actually occurs between sustain electrode SU1 and scan electrode SC1. With this setting, the discharge caused between data electrode Dk and scan electrode SC1 can trigger the discharge between the areas of sustain electrode SU1 and scan electrode SC1 intersecting with data electrode Dk. Thus, an address discharge occurs in the discharge cells to be lit. Positive wall voltage accumulates on scan electrode SC1 and negative wall voltage accumulates on sustain electrode SU1. Negative wall voltage also accumulates on data electrode Dk.

In this manner, the address operation is performed to cause the address discharge in the discharge cells to be lit in the first row and to accumulate wall voltages on the corresponding electrodes. On the other hand, the voltage in the intersecting parts of scan electrode SC1 and data electrode D1 through data electrode Dm applied with no address pulse voltage Vd does not exceed the breakdown voltage, and thus no address discharge occurs. The above address operation is repeated until the operation reaches the discharge cells in the n-th row, and the address period is completed.

In the subsequent sustain period, sustain pulses equal in number to the luminance weight multiplied by a predetermined luminance magnification are alternately applied to display electrode pairs 24. Thereby, a sustain discharge is caused in the discharge cells having undergone the address discharge, for light emission.

In this sustain period, first, positive sustain pulse voltage Vs is applied to scan electrode SC1 through scan electrode SCn, and the ground potential as a base potential, i.e. 0 (V), is applied to sustain electrode SU1 through sustain electrode SUn. Then, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs, and thus exceeds the breakdown voltage.

Then, a sustain discharge occurs between scan electrode SCi and sustain electrode SUi, and ultraviolet light generated at this time causes phosphor layers 35 to emit light. Thus, negative wall voltage accumulates on scan electrode SCi, and positive wall voltage accumulates on sustain electrodes SUi. Positive wall voltage also accumulates on data electrode Dk. In the discharge cells having undergone no address discharge in the address period, no sustain discharge occurs and the wall voltage at the completion of the initializing period is maintained.

Subsequently, 0 (V) as the base potential is applied to scan electrode SC1 through scan electrode SCn, and sustain pulse voltage Vs is applied to sustain electrode SU1 to sustain electrode SUn. In the discharge cell having undergone the sustain discharge, the voltage difference between sustain electrode SUi and scan electrode SCi exceeds the breakdown voltage. Thereby, a sustain discharge occurs between sustain electrode SUi and scan electrode SCi again. Thus, negative wall voltage accumulates on sustain electrode SUi, and positive wall voltage accumulates on scan electrode SCi. Similarly, sustain pulses equal in number to the luminance weight multiplied by the luminance magnification are alternately applied to scan electrode SC1 through scan electrode SCn and sustain electrode SU1 through sustain electrode SUn to cause a potential difference between the electrodes of display electrode pairs 24. Thereby, the sustain discharge is continued in the discharge cells having undergone the address discharge in the address period.

After the sustain pulses have been generated in the sustain period, ramp voltage (hereinafter, referred to as “erasing ramp voltage”) L3 gradually rising from 0 (V) toward voltage Vers is applied to scan electrode SC1 through scan electrode SCn. Thereby, in the discharge cells having undergone the sustain discharge, a weak discharge is continuously caused, and a part or the whole of the wall voltages on scan electrode SCi and sustain electrode SUi is erased while the positive wall voltage is left on data electrode Dk.

Specifically, after the voltage applied to sustain electrode SU1 through sustain electrode SUn is returned to 0 (V), erasing ramp voltage L3, which rises from 0 (V) as the base potential toward voltage Vers exceeding the breakdown voltage, is generated at a gradient (of approximately 10 V/μsec, for example) steeper than the gradient of up-ramp voltage L1. The erasing ramp voltage L3 is applied to scan electrode SC1 through scan electrode SCn. Then, a weak discharge occurs between sustain electrode SUi and scan electrode SCi in the discharge cell having undergone the sustain discharge. This weak discharge continuously occurs while the voltage applied to scan electrode SC1 through scan electrode SCn is rising. After the rising voltage has reached voltage Vers as a predetermined voltage, the voltage applied to scan electrode SC1 through scan electrode SCn is dropped to 0 (V) as the base potential.

At this time, the charged particles generated by this weak discharge accumulate on sustain electrode SUi and scan electrode SCi as wall charge so as to reduce the voltage difference between sustain electrode SUi and scan electrode SCi. Thereby, while the positive wall charge is left on data electrode Dk, the wall voltage between scan electrode SC1 through scan electrode SCn and sustain electrode SU1 through sustain electrode SUn is reduced to the difference between the voltage applied to scan electrode SCi and the breakdown voltage, i.e. a degree of (voltage Vers−breakdown voltage). Hereinafter, the last discharge in the sustain period caused by erasing ramp voltage L3 is referred to as “erasing discharge”.

The respective operations in the subsequent second SF and thereafter are substantially similar to the above operation except for the number of sustain pulses in the sustain periods, and thus the description is omitted. The above description has outlined the driving voltage waveforms applied to the respective electrodes of panel 10 in this exemplary embodiment.

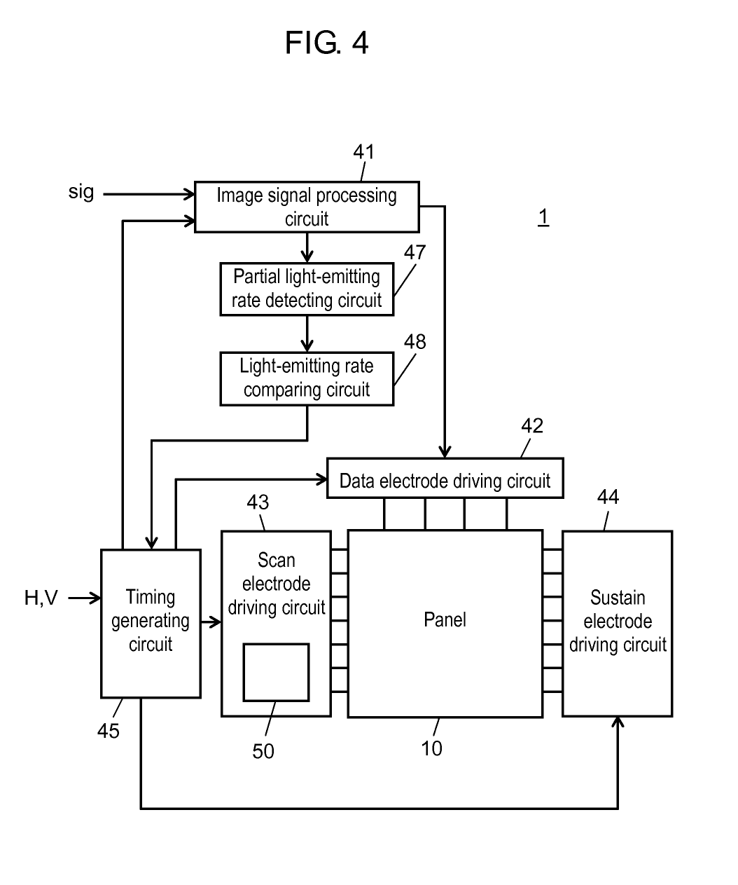

Next, a structure of plasma display device 1 in accordance with this exemplary embodiment is described. FIG. 4 is a circuit block diagram of plasma display device 1 in accordance with the first exemplary embodiment of the present invention. Plasma display device 1 has the following elements:
panel 10;
image signal processing circuit 41;
data electrode driving circuit 42;
scan electrode driving circuit 43;
sustain electrode driving circuit 44;
timing generating circuit 45;
partial light-emitting rate detecting circuit 47;
light-emitting rate comparing circuit 48; and
power supply circuits (not shown) for supplying power necessary for each circuit block.

Image signal processing circuit 41 converts input image signal sig to image data showing light emission and no light emission in each subfield.

Partial light-emitting rate detecting circuit 47 divides the display area of panel 10 into a plurality of regions, and detects a rate of the number of discharge cells to be lit with respect to the number of all the discharge cells in each of the regions, in each subfield, according to the image data in each subfield (hereinafter, the rate being referred to as “partial light-emitting rate”). For example, when the number of discharge cells in one region is 518400 and the number of discharge cells to be lit in the region is 259200, the partial light-emitting rate of the region is 50%. Partial light-emitting rate detecting circuit 47 may detect a light-emitting rate in one display electrode pair 24, for example, as a partial light-emitting rate. However, herein, as one region, the partial light-emitting rate detecting circuit detects the partial light-emitting rate in a region that is formed of a plurality of scan electrodes 22 connected to one of integrated circuits (ICs) for driving scan electrodes 22 (hereinafter referred to as “scan ICs”).

Light-emitting rate comparing circuit 48 compares the values of the partial light-emitting rates of the respective regions detected in partial light-emitting rate detecting circuit 47, and determines the ranking of the regions in decreasing order of value. The light-emitting rate comparing circuit outputs the signal showing the result to timing generating circuit 45 for each subfield.

Timing generating circuit 45 generates various timing signals for controlling the operation of each circuit block according to horizontal synchronizing signal H, vertical synchronizing signal V, and the output from light-emitting rate comparing circuit 48, and supplies the timing signals to each circuit block.

Scan electrode driving circuit 43 has the following elements:
an initializing waveform generating circuit (not shown) for generating initializing waveform voltages to be applied to scan electrode SC1 through scan electrode SCn in the initializing periods;
a sustain pulse generating circuit (not shown) for generating sustain pulses to be applied to scan electrode SC1 through scan electrode SCn in the sustain periods; and
scan pulse generating circuit 50 having a plurality of scan ICs, for generating scan pulse voltage Va to be applied to scan electrode SC1 through scan electrode SCn in the address periods.
   The scan electrode driving circuit 43 drives each of scan electrode SC1 through scan electrode SCn, according to the timing signals. At this time, in this embodiment, scan ICs are sequentially switched for the address operation so that the address operation is performed earlier on the regions having the higher partial light-emitting rates in decreasing order of value. Thereby, a stable address discharge is caused. A detailed description will be given later.

Data electrode driving circuit 42 converts image data in each subfield into signals corresponding to each of data electrode D1 through data electrode Dm, and drives each of data electrode D1 through data electrode Dm according to the timing signals. As described above, in this embodiment, the order of address operations can be different in each subfield. Thus, timing generating circuit 45 generates timing signals so that address pulse voltage Vd is generated in data electrode driving circuit 42 according to the order of the address operations of the scan ICs. Thereby, address operations appropriate for a display image can be performed.

Sustain electrode driving circuit 44 has a sustain pulse generating circuit, and a circuit for generating voltage Ve1 and voltage Ve2 (not shown), and drives sustain electrode SU1 through sustain electrode SUn in response to the timing signals.

Next, the details and operation of scan electrode driving circuit 43 are described.

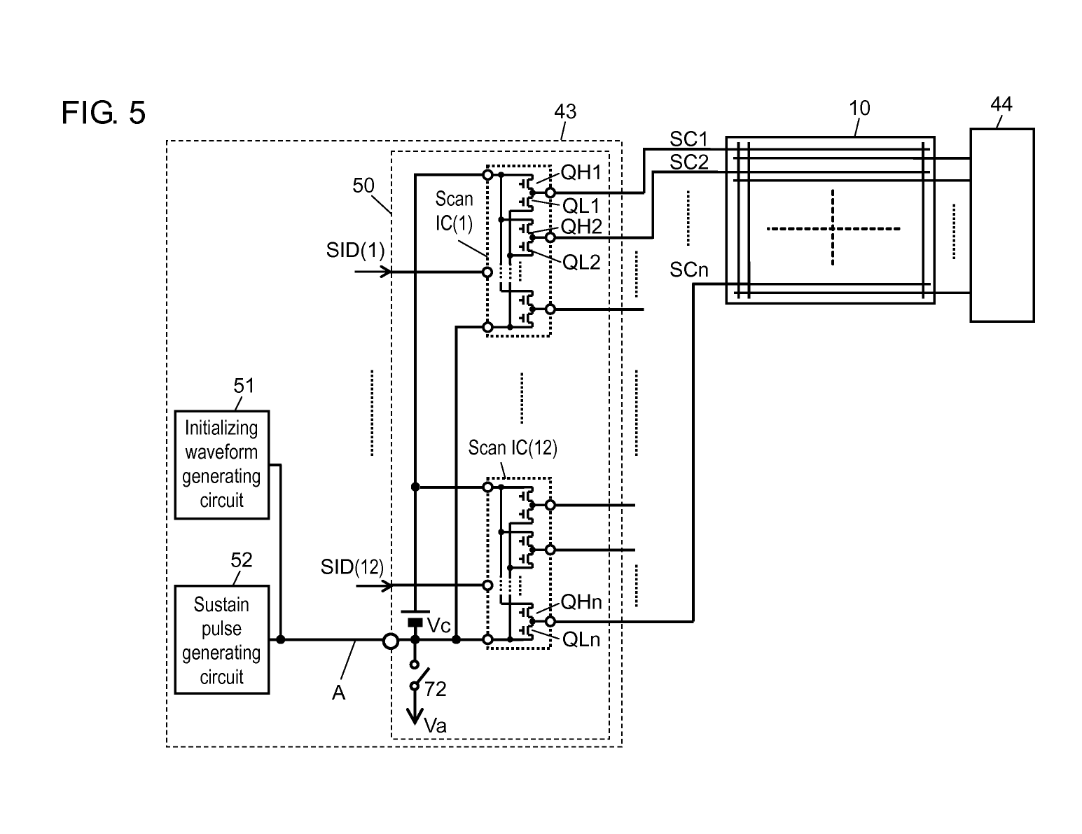

FIG. 5 is a circuit diagram showing a structure of scan electrode driving circuit 43 of plasma display device 1 in accordance with the first exemplary embodiment of the present invention. Scan electrode driving circuit 43 has scan pulse generating circuit 50, initializing waveform generating circuit 51, and sustain pulse generating circuit 52 on the side of scan electrodes 22. The outputs of scan pulse generating circuit 50 are connected to corresponding ones of scan electrode SC1 through scan electrode SCn.

Initializing waveform generating circuit 51 causes reference potential A of scan pulse generating circuit 50 to rise or fall in a ramp form in the initializing periods, thereby generating the initializing waveform voltages shown in FIG. 3.

Sustain pulse generating circuit 52 changes reference potential A of scan pulse generating circuit 50 to voltage Vs or the ground potential, thereby generating the sustain pulses shown in FIG. 3.

Scan pulse generating circuit 50 has the following elements:
switch 72 for connecting reference potential A to negative voltage Va in the address periods;
power supply VC for supplying voltage Vc; and
switching element QH1 through switching element QHn and switching element QL1 through switching element QLn for applying scan pulse voltage Va to n scan electrode SC1 through scan electrode SCn, respectively.
   Switching element QH1 through switching element QHn and switching element QL1 through switching element QLn are grouped in a plurality of outputs and formed into ICs. These ICs are scan ICs. By setting switching element QHi to OFF and setting switching element QLi to ON, negative scan pulse voltage Va is applied to scan electrode SCi via switching element QLi. In the following description, the operation of bringing a switching element into conduction is denoted as “ON”, and the operation of bringing a switching element out of conduction is denoted as “OFF”. A signal for setting a switching element to ON is denoted as “Hi”, and a signal for setting a switching element to OFF is denoted as “Lo”.

When initializing waveform generating circuit 51 or sustain pulse generating circuit 52 is operated, the initializing waveform voltage or sustain pulse voltage Vs is applied to scan electrode SC1 through scan electrode SCn via switching element QL1 through switching element QLn, by setting switching element QH1 through switching element QHn to OFF and switching element QL1 through switching element QLn to ON, respectively.

The following description is provided for a case where switching elements for 90 outputs are integrated into one monolithic IC and panel 10 has 1,080 scan electrodes 22. Then, 12 scan ICs form scan pulse generating circuit 50, and drive 1,080 electrodes, i.e. scan electrode SC1 through scan electrode SCn. In this manner, integrating a large number of switching element QH1 through switching element QHn and switching element QL1 through switching element QLn into ICs can reduce the number of components and thus the mounting area. However, the above numerical values are merely examples, and the present invention is not limited to these values.

In this embodiment, SID (1) through SID (12) output from timing generating circuit 45 are input to scan IC (1) through scan IC (12), respectively, in the address periods. These SID (1) through SID (12) are operation start signals for causing the scan ICs to start address operations. The order of the address operations of scan IC (1) through scan IC (12) is changed according to SID (1) through SID (12).

For example, scan IC (1) connected to scan electrode SC1 through scan electrode SC90 is caused to perform an address operation after scan IC (12) connected to scan electrode SC991 through scan electrode SC1080 is caused to perform an address operation. In this case, the following operation is performed.

Timing generating circuit 45 changes SID (12) from a Lo state (e.g. 0(V)) to a Hi state (e.g. 5(V)) and instructs scan IC (12) to start an address operation. Scan IC (12) detects a change in the voltage of SID (12), and starts an address operation in response to the detection. First, switching element QH991 is set to OFF, and switching element QL991 is set to ON. Thereby, via switching element QL991, scan pulse voltage Va is applied to scan electrode SC991. After the completion of the address operation on scan electrode SC991, switching element QH991 is set to ON, and switching element QL991 is set to OFF. Subsequently, switching element QH992 is set to OFF, and switching element QL992 is set to ON. Thereby, via switching element QL992, scan pulse voltage Va is applied to scan electrode SC992. The series of address operations are sequentially performed, so that scan pulse voltage Va is sequentially applied to scan electrode SC991 through scan electrode SC1080. Thus, scan IC (12) completes the address operation.

After the completion of the address operation of scan IC(12), timing generating circuit 45 changes SID (1) from the Lo state (e.g. 0(V)) to the Hi state (e.g. 5 (V)) and instructs scan IC (1) to start an address operation. Scan IC (1) detects a change in the voltage of SID (1), and starts an address operation similar to the above in response to the detection. Thus, the scan IC sequentially applies scan pulse voltage Va to scan electrode SC1 through scan electrode SC90.

In this embodiment, the order of the address operations of scan ICs can be controlled, using SIDs, i.e. operation start signals, in this manner.

In this embodiment, as described above, the order of the address operations of the scan ICs is determined, according to the partial light-emitting rates detected in partial light-emitting rate detecting circuit 47. Then, a scan IC for driving a region having a higher partial light-emitting rate is caused to perform an address operation earlier. An example of these operations is described, with reference to the accompanying drawings.

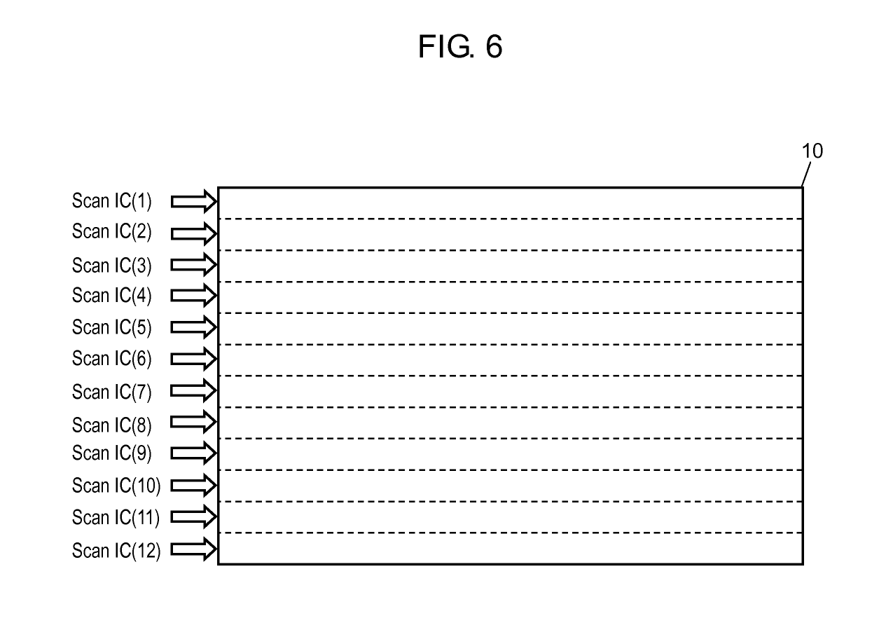

FIG. 6 is a schematic diagram showing an example of the connection between regions for detecting partial light-emitting rates and scan ICs in accordance with the first exemplary embodiment of the present invention. FIG. 6 schematically shows how panel 10 is connected to the scan ICs. Each of the areas surrounded by the broken lines in panel 10 shows the region where a partial light-emitting rate is detected. Display electrode pairs 24 are arranged so as to extend in the horizontal direction in the drawing in a similar manner to FIG. 2.

As described above, partial light-emitting rate detecting circuit 47 sets the area that is formed of a plurality of scan electrodes 22 connected to one scan IC, as one region, and detects partial light-emitting rates. For example, the number of scan electrodes 22 connected to one scan IC is 90, and scan electrode driving circuit 43 has 12 scan ICs (scan IC (1) through scan IC (12)). In this case, as shown in FIG. 6, partial light-emitting rate detecting circuit 47 sets 90 scan electrodes 22 connected to each of scan IC (1) through scan IC (12) as one region, divides the display area of panel 10 into 12 regions, and detects a partial light-emitting rate for each region. Light-emitting rate comparing circuit 48 compares the values of the partial light-emitting rates detected in partial light-emitting rate detecting circuit 47, and ranks the regions in decreasing order of value. Timing generating circuit 45 generates timing signals based on the ranking. In response to the timing signals, scan electrode driving circuit 43 causes the scan IC that is connected to the region having a higher partial light-emitting rate to perform an address operation earlier.

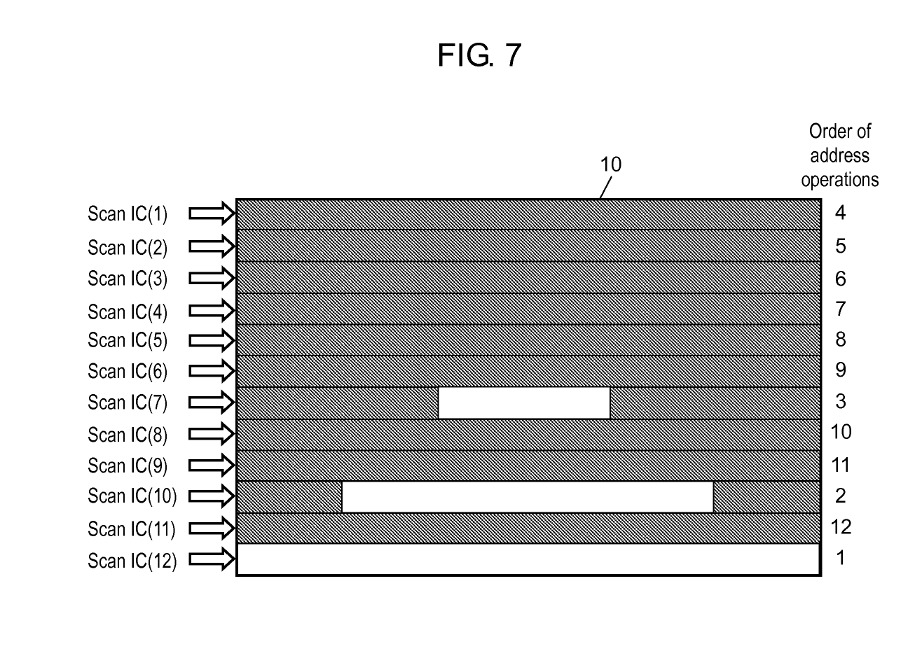

FIG. 7 is a schematic diagram showing an example of the order of address operations of scan IC (1) through scan IC (12) in accordance with the first exemplary embodiment of the present invention. In FIG. 7, the regions where partial light-emitting rates are detected are similar to the regions shown in FIG. 6. The diagonally shaded portion shows the distribution of unlit cells where no sustain discharge is caused. The outline portion not diagonally shaded shows the distribution of lit cells where a discharge is caused.

For example, when lit cells are distributed as shown in FIG. 7 in a subfield, the region having the highest partial light-emitting rate is the region connected to scan IC (12) (hereinafter, a region connected to scan IC (n) being referred to as “region (n)”). The region having the second highest partial light-emitting rate is region (10) connected to scan IC (10). The region having the third highest partial light-emitting rate is region (7) connected to scan IC (7). At this time, in a conventional address operation, the address operation is sequentially switched from scan IC (1) to scan IC (2) and scan IC (3). Thus, the address operation of scan IC (12) connected to the region having the highest partial light-emitting rate is started last. However, in this exemplary embodiment, the scan IC connected to the region having a higher light-emitting rate is caused to perform an address operation earlier. Therefore, as shown in FIG. 7, first, scan IC (12) is caused to perform an address operation. Second, scan IC (10) is caused to perform an address operation. Third, scan IC (7) is caused to perform an address operation. In this exemplary embodiment, at an equal partial light-emitting rate, the scan IC connected to scan electrodes 22 in the upper position is caused to perform an address operation earlier. As a result, the address operation of scan IC (7) and thereafter is caused in the following order: scan IC (1), scan IC (2), scan IC (3), scan IC (4), scan IC (5), scan IC (6), scan IC (8), scan IC (9), and scan IC (11). The address operation is performed on the regions in the following order: region (12), region (10), region (7), region (1), region (2), region (3), region (4), region (5), region (6), region (8), region (9), and region (11).

In this manner, in this exemplary embodiment, the scan IC connected to the region having a higher partial light-emitting rate is caused to perform an address operation earlier. Thus, the address operation is performed earlier on the regions having the higher partial light-emitting rates, thereby causing a stable address discharge. This is due to the following reasons.

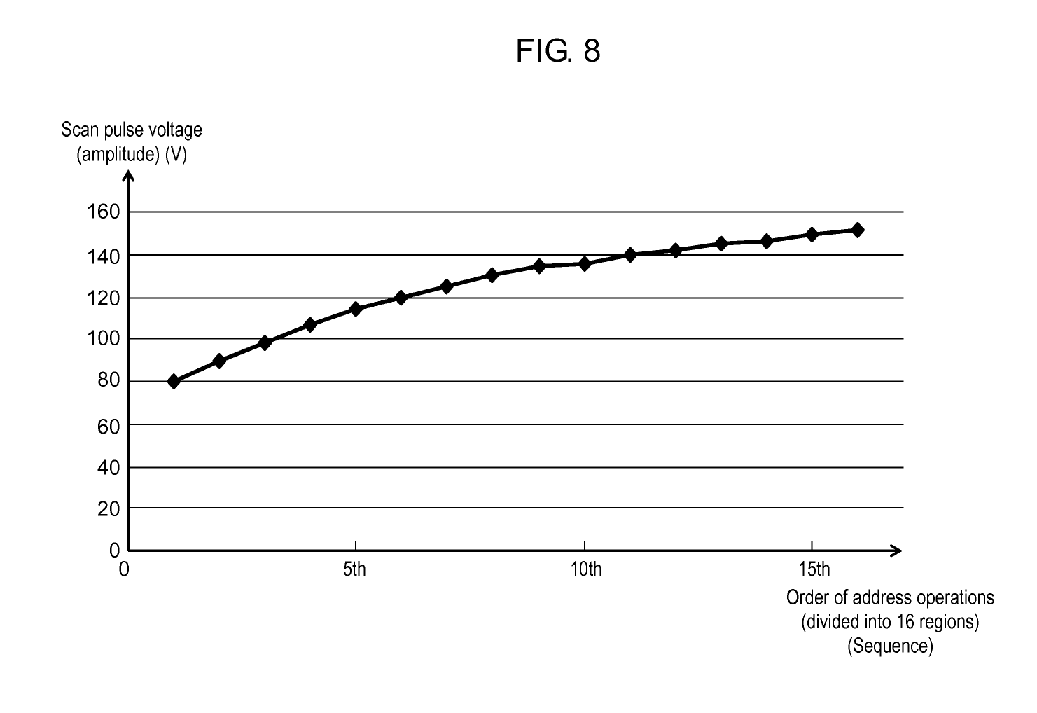

FIG. 8 is a characteristics chart showing the relation between the order of address operations of the scan ICs and a scan pulse voltage (amplitude) necessary for causing a stable address discharge in accordance with the first exemplary embodiment of the present invention. In FIG. 8, the vertical axis shows a scan pulse voltage (amplitude) necessary for causing a stable address discharge, and the horizontal axis shows the order of the address operations of the scan ICs. In this experiment, the display area of panel 10 is divided into 16 regions, and scan pulse generating circuit 50 has 16 scan ICs so as to drive scan electrode SC1 through scan electrode SCn. Then, it is measured how the scan pulse voltage (amplitude) necessary for causing a stable address discharge changes according to the order of the address operations of the scan ICs.

As shown in FIG. 8, according to the order of the address operations of the scan ICs, the scan pulse voltage (amplitude) necessary for causing a stable address discharge changes. Specifically, in a scan IC in a later part of the sequence of the address operations, the scan pulse voltage (amplitude) necessary for causing a stable address discharge is higher. For example, in the scan IC caused to perform the address operation first, the scan pulse voltage (amplitude) necessary for causing a stable address discharge is approximately 80 (V). In the scan IC caused to perform the address operation last (the 16th, herein), the necessary scan pulse voltage (amplitude) is approximately 150 (V), which is higher by approximately 70 (V).

This is considered to result from a gradual decrease in the wall charge formed in the initializing period with a lapse of time. Further, because address pulse voltage Vd is applied to corresponding data electrodes 32 in the address period (according to a display image), address pulse voltage Vd is also applied to the discharge cells undergoing no address operation. Such a voltage change also reduces the wall charge. Thus, it is considered that the wall charge further decreases in the discharge cells undergoing the address operation in a later part of the address period.

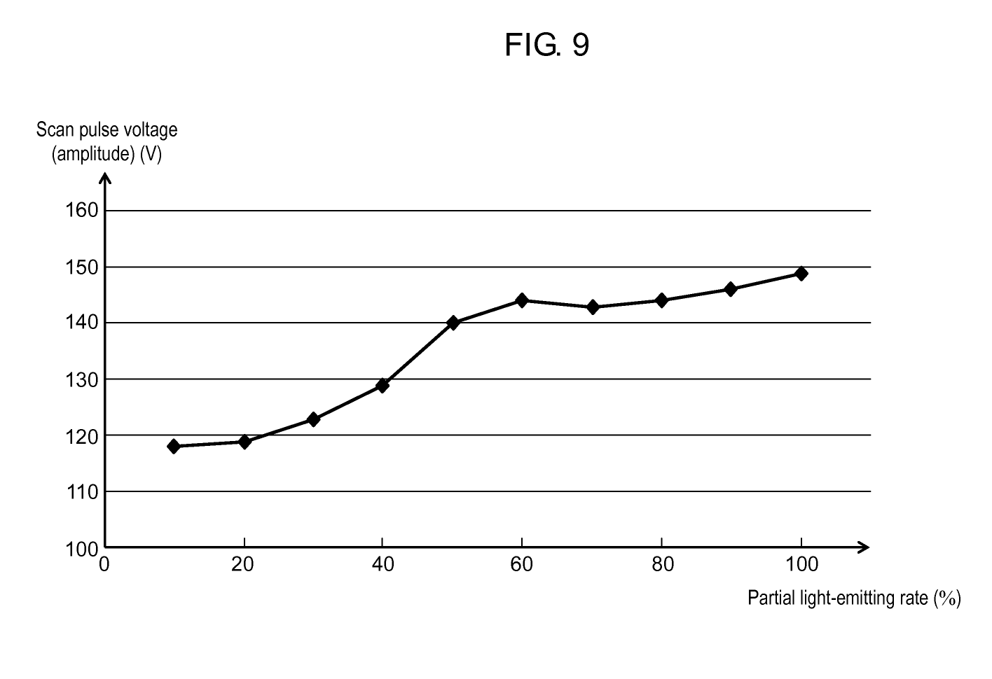

FIG. 9 is a characteristics chart showing the relation between a partial light-emitting rate and a scan pulse voltage (amplitude) necessary for causing a stable address discharge in accordance with the first exemplary embodiment of the present invention. In FIG. 9, the vertical axis shows the scan pulse voltage (amplitude) necessary for causing a stable address discharge, and the horizontal axis shows a partial light-emitting rate. In this experiment, in a similar manner to the measurement of FIG. 8, the display area of panel 10 is divided into 16 regions. Further, it is measured how the scan pulse voltage (amplitude) necessary for causing a stable address discharge changes as the rate of lit cells is changed in one of the regions.

As shown in FIG. 9, according to the rate of lit cells, the scan pulse voltage (amplitude) necessary for causing a stable address discharge changes. Specifically, at a higher light-emitting rate, the scan pulse voltage (amplitude) necessary for causing a stable address discharge is higher. For example, at a light-emitting rate of 10%, the scan pulse voltage (amplitude) necessary for causing a stable address discharge is approximately 118 (V). At a light-emitting rate of 100%, the necessary scan pulse voltage (amplitude) is approximately 149 (V), which is higher by approximately 31 (V).

This is considered because, as the number of lit cells and thus the light-emitting rate increase, the discharge current and the voltage drop of the scan pulse voltage (amplitude) increase. In addition, as an increase in the screen size of panel 10 increases the length of scan electrodes 22 and thus their drive load, the voltage drop further increases.

In this manner, the scan pulse voltage (amplitude) necessary for causing a stable address discharge is higher in a scan IC that performs an address operation later, i.e. in the longer lapse of time from the initializing operation to address operation. The scan pulse voltage is also higher at the higher light-emitting rate. Therefore, when a scan IC that performs an address operation later is connected to a region having a higher light-emitting rate, the scan pulse voltage (amplitude) necessary for causing a stable address operation is further increased.

However, in a case where a scan IC is connected to a region having a higher partial light-emitting rate but caused to perform the address operation earlier, the scan pulse voltage (amplitude) necessary for causing a stable address discharge can be made smaller than the scan pulse voltage when the scan IC connected to the region is caused to perform the address operation later.

Thus, in this exemplary embodiment, a partial light-emitting rate is detected per region, and the scan IC connected to the region having a higher partial light-emitting rate is caused to perform the address operation earlier. With this structure, the address operation can be performed earlier on a region having a higher partial light-emitting rate. Thus, the address operation can be performed on a region having a higher partial light-emitting rate so that the lapse of time from the initializing operation to the address operation in the region is shorter than the lapse of time to the address operation in a region having a lower partial light-emitting rate. This operation can prevent an increase in the scan pulse voltage (amplitude) necessary for causing a stable address discharge, thereby causing a stable address discharge. In the experiments, the inventor has verified that the structure of this exemplary embodiment can reduce the scan pulse voltage (amplitude) necessary for causing a stable address discharge, by approximately 20 (V), which depends on display images.

Next, a description is provided for an example of a circuit for generating SIDs (SID (1) through SID (12), herein), i.e. operation start signals to scan ICs, as shown in FIG. 5, with reference to the accompanying drawings.

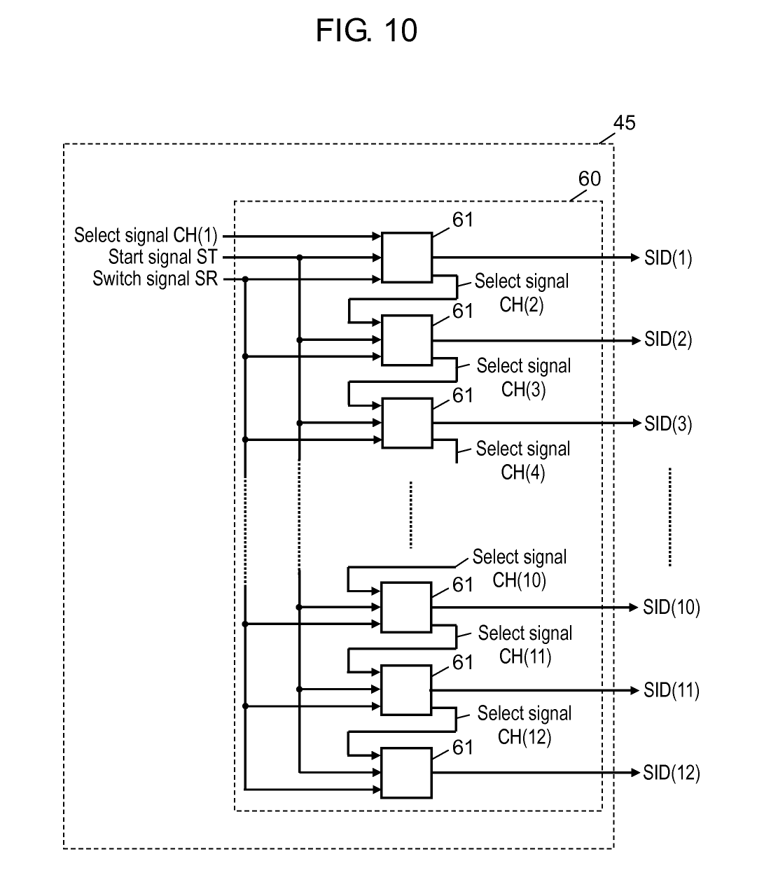

FIG. 10 is a circuit block diagram showing a configuration example of scan IC switching circuit 60 in accordance with the first exemplary embodiment of the present invention. Timing generating circuit 45 has scan IC switching circuit 60 for generating SIDs (SID (1) through SID (12), herein). Though not shown herein, clock signal CK, i.e. the reference of operation timing of each circuit, is input to scan IC switching circuit 60.

As shown in FIG. 10, scan IC switching circuit 60 has SID generating circuits 61 equal in number to SIDs to be generated (12 circuits, herein). Switch signal SR generated according to the comparison result in light-emitting rate comparing circuit 48, select signal CH generated in a scan IC selecting sub-period in each address period, and start signal ST generated at the start of the address operation of the scan IC are input to each SID generating circuit 61. Then, each SID generating circuit 61 outputs the SID based on the corresponding input signals. Each of the signals is generated in timing generating circuit 45 except that select signal CH delayed by a predetermined time period in each SID generating circuit 61 is used for SID generating circuit 61 at the next stage. For example, select signal CH (1) input to first SID generating circuit 61 is delayed in this SID generating circuit 61 by the predetermined time period to provide select signal CH (2), and this select signal CH (2) is input to SID generating circuit 61 at the next stage. Therefore, to respective SID generating circuits 61, switch signals SR and start signals ST are input at the same timing, but select signals CH are all input at different timings.

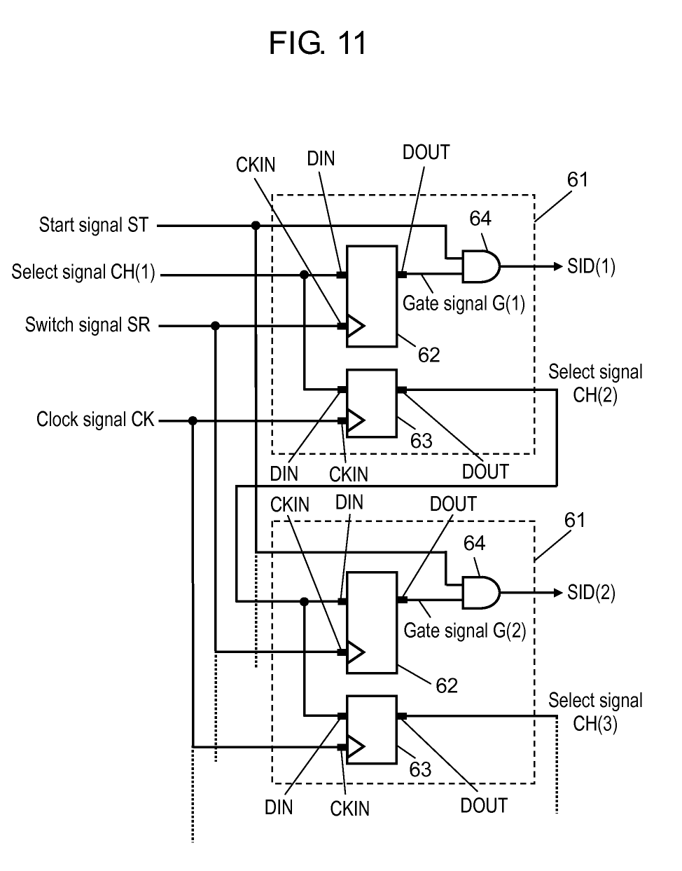

FIG. 11 is a circuit diagram showing a configuration example of SID generating circuits 61 in accordance with the first exemplary embodiment of the present invention. Each SID generating circuit 61 has flip-flop circuit (hereinafter, simply referred to as “FF”) 62, delay circuit 63, and AND gate 64.

FF 62 is configured and operates in a similar manner to a generally known flip-flop circuit. The FF has clock input terminal CKIN, data input terminal DIN, and data output terminal DOUT. The FF holds the state (Lo or Hi) of data input terminal DIN (select signal CH being input, herein) on the rising edge (at the time of changing from Lo to Hi) of the signal that is input to clock input terminal CKIN (switch signal SR, herein), and outputs the inverted state, as gate signal G, from data output terminal DOUT.

In AND gate 64, gate signal G output from FF 62 is input to one input terminal, and start signal ST is input to the other input terminal. The AND gate performs an AND operation on the two signals, and outputs the result. That is, only when gate signal G is in the Hi state and start signal ST is in the Hi state, the Hi state is output. In the other cases, the Lo state is output. The output of AND gate 64 is an SID.

Delay circuit 63 is configured and operates in a similar manner to a generally known delay circuit. The delay circuit has clock input terminal CKIN, data input terminal DIN, and data output terminal DOUT. The delay circuit delays a signal that is input to data input terminal DIN (select signal CH, herein) by a predetermined cycle (one cycle, herein) of clock signal CK that is input to clock input terminal CKIN, and outputs the delayed signal from data output terminal DOUT. This output is used as select signal CH in SID generating circuit 61 at the next stage.

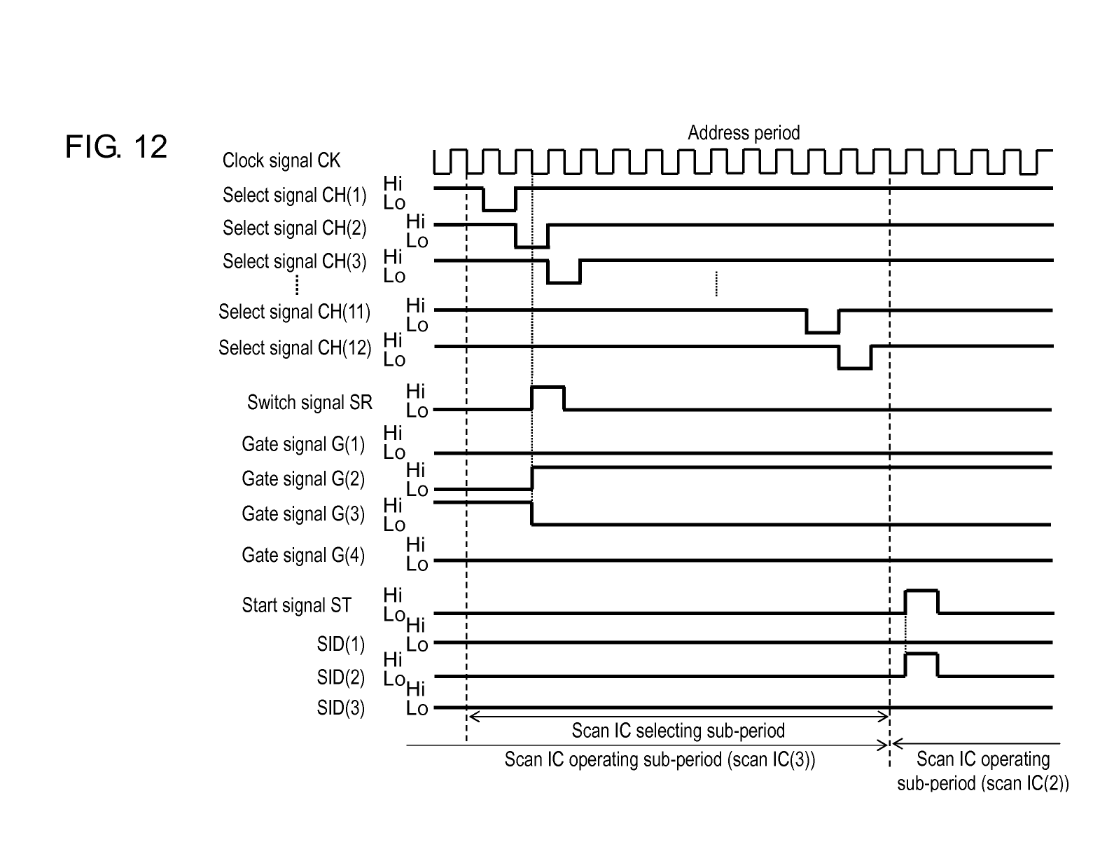

These operations are described with reference to a timing chart. FIG. 12 is a timing chart for explaining an operation of scan IC switching circuit 60 in accordance with the first exemplary embodiment of the present invention. Herein, a description is provided, using the operation of scan IC switching circuit 60 when scan IC (2) is caused to perform an address operation next to scan IC (3), as an example. Each of the signals shown herein is generated after the generation timing thereof is determined in timing generating circuit 45, according to the comparison result of light-emitting rate comparing circuit 48.

In this exemplary embodiment, a scan IC to be caused to perform the address operation next is determined in a scan IC selecting sub-period set in each address period. However, the scan IC selecting sub-period for determining the scan IC to be caused to perform the address operation first is set immediately before each address period. In a position immediately before the address operation of a scan IC under address operation is completed, the scan IC selecting sub-period for determining a scan IC to be caused to perform an address operation next is set.

In the scan IC selecting sub-period, first, select signal CH (1) is input to SID generating circuit 61 for generating SID (1). As shown in FIG. 12, this select signal CH (1) has a pulse waveform of negative polarity that is in the Hi state normally and in the Lo state only in the period equal to one cycle of clock signal CK. Select signal CH (1) is delayed by one cycle of clock signal CK in SID generating circuit 61, to provide select signal CH (2), which is input to SID generating circuit 61 for generating SID (2). Thereafter, select signal CH (3) through select signal CH (12), each delayed by one cycle of clock signal CK, are input to corresponding SID generating circuits 61.

As shown in FIG. 12, switch signal SR has a pulse waveform of positive polarity that is in the Lo state normally and in the Hi state only in the period equal to one cycle of clock signal CK. The positive pulse is generated at a timing at which select signal CH for selecting the scan IC to be caused to perform the address operation next changes to the Lo state, among select signal CH (1) through select signal CH (12) each delayed by one cycle of clock signal CK. With this operation, FF 62 outputs, as gate signal G, a signal that shows the inverted state of the state of select signal CH on the rising edge of switch signal SR input to clock input terminal CKIN.

For example, when scan IC (2) is selected, a positive pulse is generated as switch signal SR at the time point when select signal CH (2) changes to the Lo state, as shown in FIG. 12. At this time, select signals CH except select signal CH (2) are all in the Hi state. Thus, only gate signal G (2) is in the Hi state and the other gate signals G are in the Lo state. Herein, gate signal G (3) changes from the Hi state to the Lo state at this timing.

Switch signal SR may be generated so as to change the state thereof in synchronization with the falling edge of clock signal CK. This operation can provide a time lag by a half of the cycle of clock signal CK with respect to a change in the state of select signals CH. Thus, the operation in FF 62 can be ensured.

Next, at the timing at which the address operation of the scan IC is started, a positive pulse that is in the Hi state in the period equal to one cycle of clock signal CK is generated as start signal ST. Start signal ST is input to each SID generating circuit 61 in common. However, only AND gate 64 where gate signal G is in the Hi state can output a positive pulse. Thus, a scan IC to be caused to perform an address operation next can be optionally determined. Herein, gate signal G (2) is in the Hi state, and thus a positive pulse is generated as SID (2), and scan IC (2) starts the address operation.

With the above circuit configuration, SIDs can be generated. However, the circuit configuration shown herein is merely an example, and the present invention is not limited to this circuit configuration. Any configuration may be used as long as the configuration is capable of generating SIDs for instructing the scan ICs to start address operations.

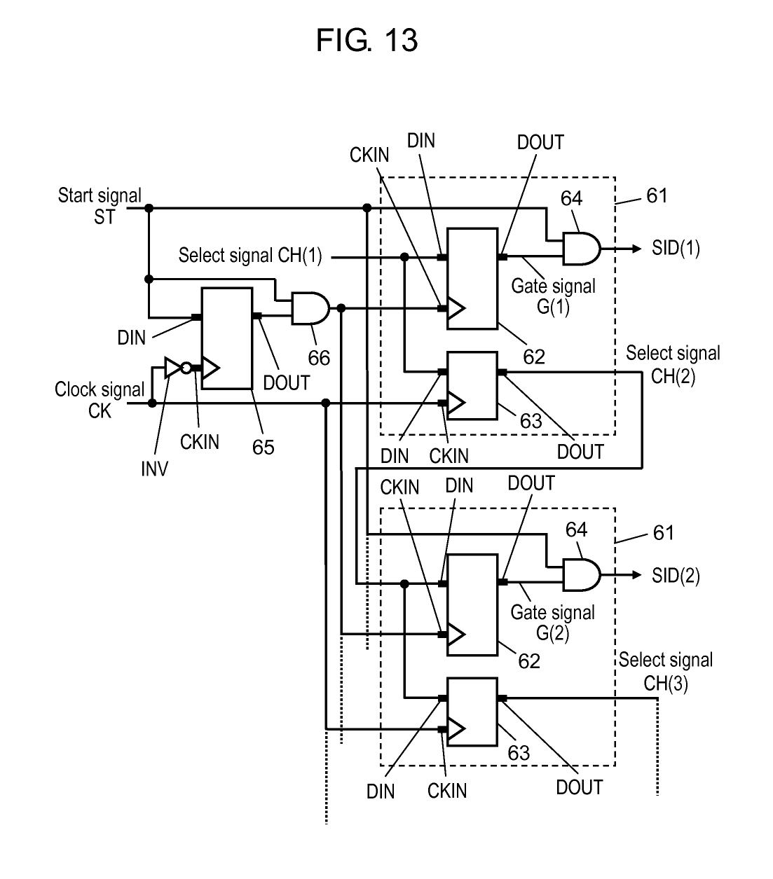

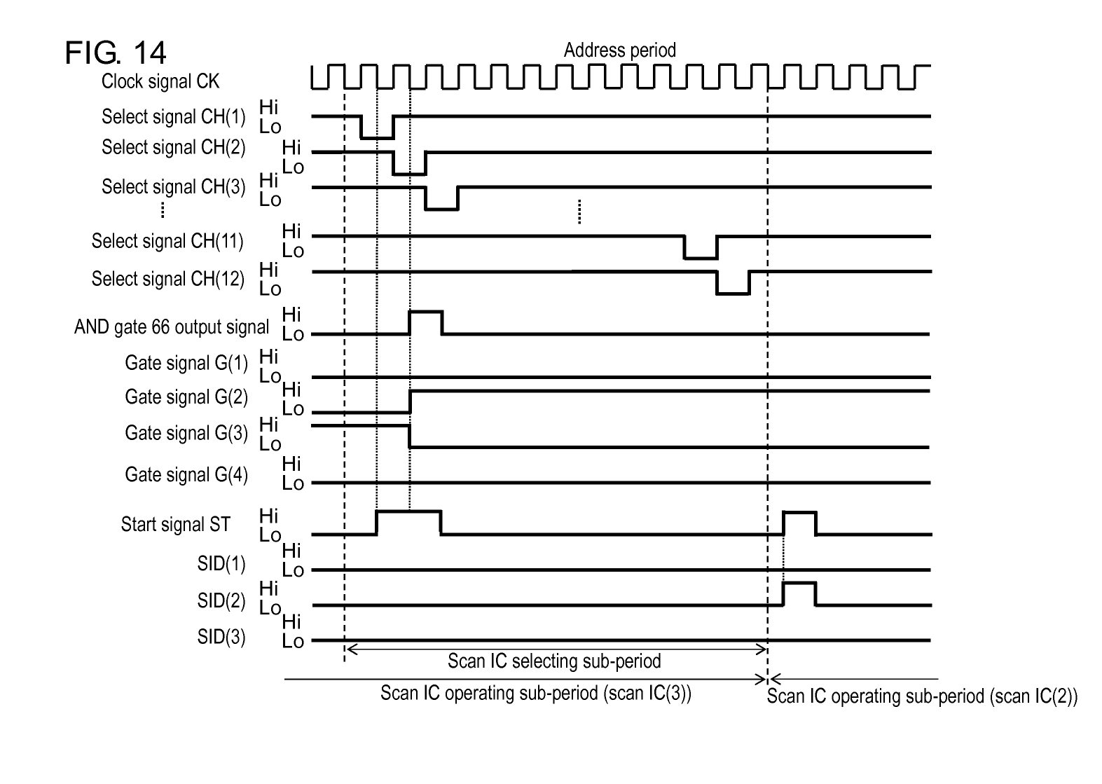

FIG. 13 is a circuit diagram showing another configuration example of the scan IC switching circuit in accordance with the first exemplary embodiment of the present invention. FIG. 14 is a timing chart for explaining another example of the scan IC switching operation in accordance with the first exemplary embodiment.

For example, as shown in FIG. 13, the circuit may be configured so that start signal ST is delayed in FF 65 by one cycle of clock signal CK, and AND gate 66 performs an AND operation on start signal ST and start signal ST delayed in FF 65 by one cycle of clock signal CK. At this time, it is preferable that clock signal CK that has a reverse polarity of clock signal CK made by logical inverter INV is input to clock input terminal CKIN of FF 65. In this configuration, when, as start signal ST, a positive pulse that is in the Hi state in the period equal to two cycles of clock signal CK is generated, a positive pulse in the Hi state in the period equal to one cycle of clock signal CK is output from AND gate 66. However, even when, as start signal ST, a positive pulse that is in the Hi state in the period equal to one cycle of clock signal CK is generated, AND gate 66 only outputs the Lo state.

Therefore, as shown in FIG. 14, instead of switch signal SR, a positive pulse that is in the Hi state in the period equal to two cycles of clock signal CK is generated, as start signal ST. Then, a positive pulse output from AND gate 66 can be used as an alternative signal of switch signal SR. That is, in this configuration, start signal ST can serve as switch signal SR as well as original start signal ST. Thus, the operation similar to the above can be performed without switch signal SR.

As described above, in the structure of this exemplary embodiment, the display area of panel 10 is divided into a plurality of regions, partial light-emitting rate detecting circuit 47 detects a partial light-emitting rate in each region, and the address operation is performed earlier on the regions having the higher partial light-emitting rates. This structure can prevent an increase in the scan pulse voltage (amplitude) necessary for causing a stable address discharge, thereby causing a stable address discharge.

In the structure described in this exemplary embodiment, each region is set according to scan electrodes 22 connected to one scan IC. However, the present invention is not limited to this structure, and each region may be set according to other dividing methods. For example, in a structure where the scanning order of scan electrodes 22 can be optionally changed for each of the scan electrodes, a partial light-emitting rate may be detected for each scan electrode 22 as one region, and the order of the address operations on scan electrodes 22 may be changed according to the detection result.

In the structure described in this exemplary embodiment, a partial light-emitting rate is detected in each region and the address operation is performed earlier on the regions having the higher partial light-emitting rates. However, the present invention is not limited to this structure. For example, the following structure may be used. The light-emitting rate in one display electrode pair 24 is detected, as a line light-emitting rate, in each display electrode pair 24, the highest line light-emitting rate is detected as a peak light-emitting rate in each region, and the address operation is performed earlier on the regions having the higher peak light-emitting rates.

The polarity of each signal shown in the explanation of the operation of scan IC switching circuit 60 is merely an example. The signal may have the polarity reverse to the polarity shown in the explanation.

### Example 2

In this exemplary embodiment, in one of subfields where the rate of the luminance weight in one field is equal to or higher than a predetermined rate, or the number of sustain pulses generated in the sustain period is equal to or larger than a predetermined number, the scan ICs are sequentially switched according to the detection result in the partial light-emitting rate detecting circuit. That is, the address operation is performed earlier on the regions having the higher partial light-emitting rates in decreasing order of value as described in the first exemplary embodiment. Further, in one of the subfields where the rate of the luminance weight in one field is lower than the predetermined rate, or the number of sustain pulses generated in the sustain period is smaller than the predetermined number, the address operation is performed by applying scan pulse voltage Va to scan electrode SC1 through scan electrode SCn in a predetermined order. For example, scan ICs are operated so as to sequentially apply scan pulse voltage Va to scan electrode SC1 through scan electrode SCn in order. This structure further stabilizes the address discharge and enhances the image display quality.

In one of the subfields where the rate of the luminance weight in one field is lower than the predetermined rate, or the number of sustain pulses generated in the sustain period is smaller than the predetermined number, the address operation is performed by applying scan pulse voltage Va to scan electrode SC1 through scan electrode SCn in the predetermined order. The reason for this operation is described.

The luminance in each subfield is expressed by the following equation (for differentiation between the brightness caused by one discharge and the brightness caused by repeated discharges, hereinafter, the former being referred to as “emission luminance” and the latter as “luminance”):

(Luminance in a subfield)=(luminance that is caused by sustain discharge caused in the sustain period of the subfield)+(luminance that is caused by address discharge caused in the address period of the subfield)

However, in a subfield where the rate of the luminance weight in one field is high, or the number of sustain pulses generated in the sustain period is large (hereinafter, “high subfield”), the luminance caused in the sustain period is sufficiently larger than the luminance caused in the address period. Therefore, the influence of the luminance caused in the address period on the luminance in the subfield is at a substantially negligible level. That is, the luminance in a high subfield can be expressed by the following equation:

(Luminance in a subfield)=(luminance that is caused by sustain discharge caused in the sustain period of the subfield)

In contrast, in a subfield where the rate of the luminance weight in one field is low, or the number of sustain pulses generated in the sustain period is small (hereinafter, “low subfield”), the luminance caused in the sustain period is small, and thus the luminance caused in the address period is relatively large. Therefore, for example, when the discharge intensity of an address discharge and thus the emission luminance caused by the address discharge are changed, the luminance of the subfield can be changed by the influence.

The discharge intensity of the address discharge can change according to the order of address operations in some cases. This is due to a decrease in the wall charge with a lapse of time from the initializing operation. In a discharge cell undergoing an address operation earlier, the discharge intensity of the address discharge and the emission luminance caused by the address discharge are relatively high. In a discharge cell undergoing address operation later, the discharge intensity of the address discharge and the emission luminance caused by the address discharge are lower than those in a cell undergoing address operation earlier.

Therefore, it is considered that, in a low subfield, a discharge cell undergoing address operation later has the lower luminance. This luminance change is small and thus less likely to be perceived. However, in some distribution patterns of lit cells, the change is likely to be perceived.

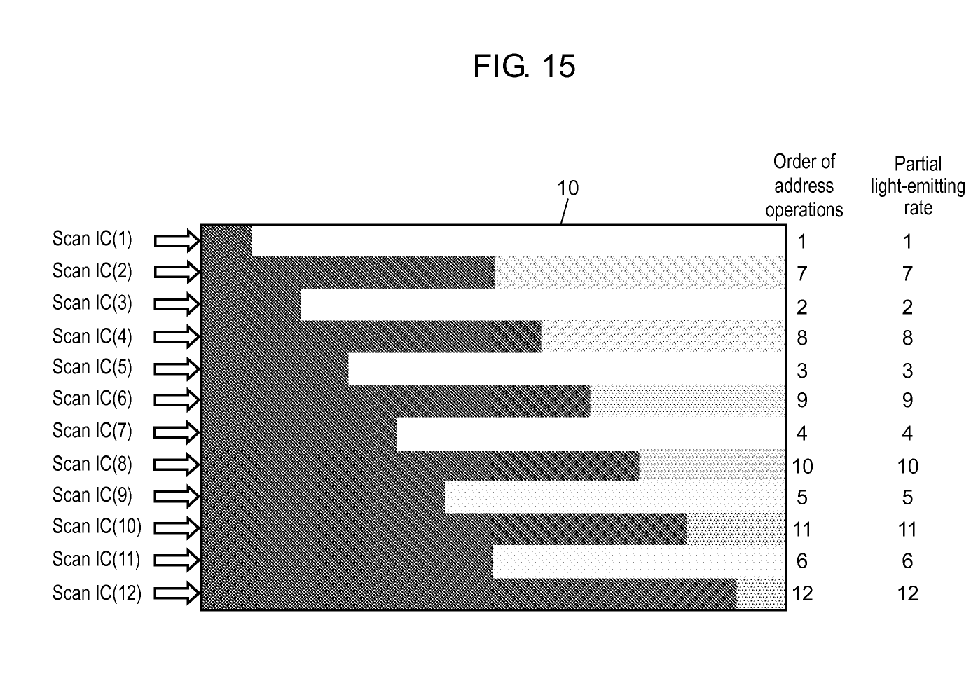

FIG. 15 is a diagram schematically showing a light emission state in a low subfield (e.g. the first SF) when a predetermined image is displayed by address operations in an order based on partial light-emitting rates. In FIG. 15, the black portion (hatched regions) shows unlit cells, and the white portion (not hatched regions) shows lit cells.

In this display image, the region having the highest partial light-emitting rate is region (1) (the region connected to scan IC (1)), and the region having the second highest partial light-emitting rate is region (3) (the region connected to scan IC (3)). Thereafter, the partial light-emitting rates decrease in the following order: region (5), region (7), region (9), region (11), region (2), region (4), region (6), region (8), region (10), and region (12).

In an address operation of this image pattern according to the partial light-emitting rates, the address operation is performed on the regions in the following order: region (1), region (3), region (5), region (7), region (9), region (11), region (2), region (4), region (6), region (8), region (10), and region (12). Therefore, the region undergoing an address operation later is interposed between the regions undergoing address operations earlier. For example, between region (1) undergoing an address operation first and region (3) undergoing an address operation second, region (2) undergoing an address operation seventh is interposed. Between region (3) undergoing an address operation second and region (5) undergoing an address operation third, region (4) undergoing an address operation eighth is interposed.

As described above, the luminance of the respective regions in a low subfield gradually decreases according to the order of address operations, but the change in the luminance is small and less likely to be perceived. However, as shown in FIG. 15, when the region undergoing an address operation later is interposed between the regions undergoing address operations earlier, an area in which the luminance discontinuously changes is generated. When the change in the luminance is small but generated discontinuously, the luminance change is likely to be perceived, and can be recognized as a band-shaped noise.

Then, in this exemplary embodiment, in a subfield where the luminance caused in the sustain period is small and a change in the emission luminance caused by the address discharge is likely to be perceived, the address operation is performed in a predetermined order.

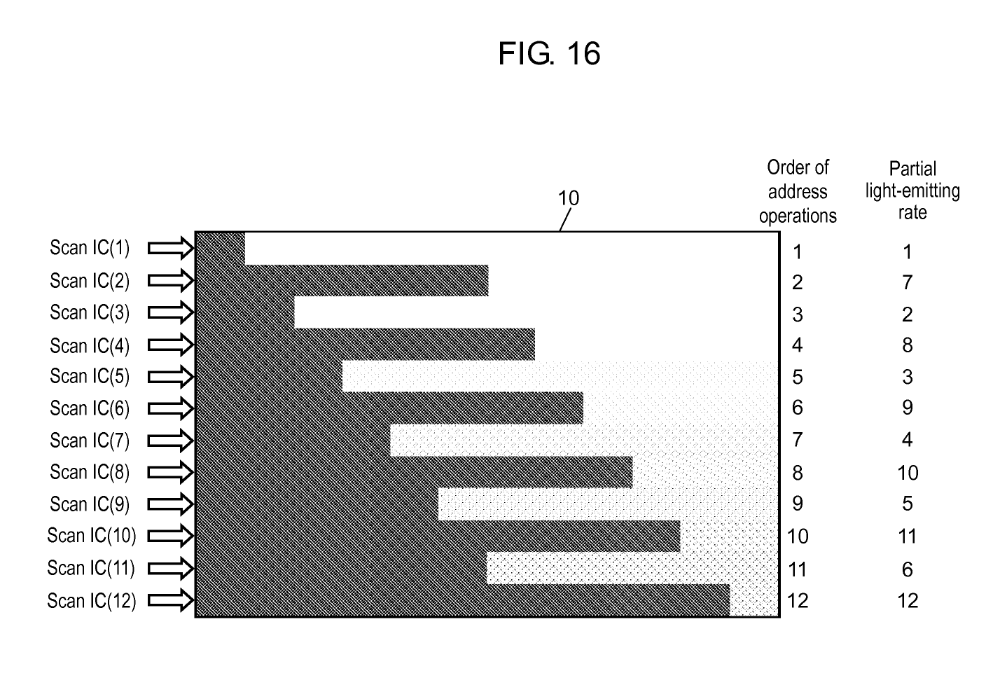

FIG. 16 is a diagram schematically showing a light emission state in a low subfield (e.g. the first SF) when an image similar to the display image of FIG. 15 is displayed by a sequential address operation from scan electrode 22 (scan electrode SC1) at the top end of panel 10 toward scan electrode 22 (scan electrode SCn) at the bottom end of panel 10.

For example, as shown in FIG. 16, when an sequential address operation is performed from scan electrode 22 (scan electrode SC1) at the top end of panel 10 toward scan electrode 22 (scan electrode SCn) at the bottom end of panel 10, the luminance of lit cells gradually decreases from the top end of panel 10 toward the bottom end of panel 10. Thus, discontinuous luminance change is not generated on the image display surface of panel 10, and the luminance change can be smoothed. Since the luminance change based on the address discharge is small, the address operation in the order such that the luminance change is smoothed can make the luminance change less likely to be perceived.

In this manner, in this exemplary embodiment, in a subfield where the luminance caused in the sustain period is small and a change in the emission luminance caused by the address discharge is likely to be perceived, the address operation is performed in the predetermined order. This operation can smooth the luminance change based on the address discharge on the image display surface of panel 10 and enhance the image display quality.

In this exemplary embodiment, the above predetermined rate can be set to 1%, for example. In this case, for example, one field is formed of eight subfields (the first SF, and the second SF through eighth SF), and the luminance weights of the respective subfields are set to 1, 2, 4, 8, 16, 32, 64, and 128. In this structure, the address operation is performed in the predetermined order in the first SF and the second SF, i.e. subfields where the rates of luminance weights in one field are each lower than 1%. Further, the address operation is performed earlier on the regions having the higher partial light-emitting rates detected in partial light-emitting rate detecting circuit 47 in the third SF through the eighth SF, i.e. subfields where the rates of luminance weights in one field are each equal to or higher than 1%.

In this exemplary embodiment, the above predetermined number can be set to 6, for example. In this case, for example, one field is formed of eight subfields (the first SF, and the second SF through eighth SF), the luminance weights of the respective subfields are set to 1, 2, 4, 8, 16, 32, 64, and 128, and the luminance magnification is set to 4. In this structure, the number of sustain pulses to be generated in the sustain period of each subfield can be obtained by quadrupling the luminance weight. Thus, in the first SF, i.e. a subfield where the number of sustain pulses is smaller than 6, the address operation is performed in the predetermined order. Further, in the second SF through the eighth SF, i.e. subfields where the numbers of sustain pulses are each equal to or larger than 6, the address operation is performed earlier on the regions having the higher partial light-emitting rates detected in partial light-emitting rate detecting circuit 47.

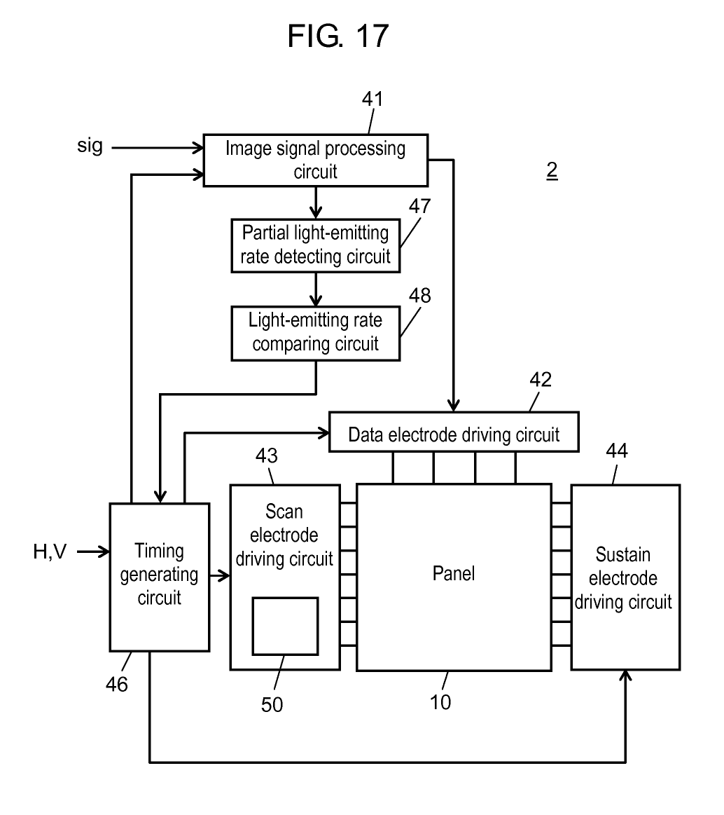

FIG. 17 is a circuit block diagram of a plasma display device in accordance with the second exemplary embodiment of the present invention.

Plasma display device 2 has the following elements:
panel 10;
image signal processing circuit 41;
data electrode driving circuit 42;
scan electrode driving circuit 43;
sustain electrode driving circuit 44;
timing generating circuit 46;
partial light-emitting rate detecting circuit 47;
light-emitting rate comparing circuit 48; and
power supply circuits (not shown) for supplying power necessary for each circuit block. The blocks configured and operating in a similar manner to those of plasma display device 1 of the first exemplary embodiment have the same reference signs, and the description thereof is omitted.

Timing generating circuit 46 generates various timing signals for controlling the operation of each circuit block according to horizontal synchronizing signal H, vertical synchronizing signal V and the output from light-emitting rate comparing circuit 48, and supplies the timing signals to each circuit block. Timing generating circuit 46 in this exemplary embodiment determines whether the current subfield is one of subfields where the rate of the luminance weight in one field is equal to or higher than a predetermined rate (e.g. 1%), or the number of sustain pulses generated in the sustain period is equal to or larger than a predetermined number (e.g. 6). Then, in one of subfields where the rate of the luminance weight in one field is equal to or higher than the predetermined rate, or the number of sustain pulses generated in the sustain period is equal to or larger than the predetermined number, the respective timing signals are generated in the following manner as described in the first embodiment. That is, the address operation is performed earlier on the regions having the higher partial light-emitting rates, according to the detection result in the partial light-emitting rate detecting circuit 47. Further, in one of subfields where the rate of the luminance weight in one field is lower than the predetermined rate, or the number of sustain pulses generated in the sustain period is smaller than the predetermined number, the respective timing signals are generated so that scan pulse voltage Va is applied to scan electrode SC1 through scan electrode SCn in the predetermined order.

As described above, in this exemplary embodiment, the address operation is switched between the following two cases. In one of subfields where the rate of the luminance weight in one field is equal to or higher than a predetermined rate, or the number of sustain pulses generated in the sustain period is equal to or larger than a predetermined number, the address operation is performed earlier on the regions having the higher partial light-emitting rates as described in the first embodiment. In contrast, in a subfield where the luminance in the sustain period is small and a change in the emission luminance caused by the address discharge is likely to be perceived, i.e. in one of the subfields where the rate of the luminance weight in one field is lower than the predetermined rate, or the number of sustain pulses generated in the sustain period is smaller than the predetermined number, the address operation is performed in a predetermined order. This operation can smooth the luminance change based on the address discharge on the image display surface of panel 10 and enhance the image display quality.

In this exemplary embodiment, as an example of the structure of the address operations on scan electrodes 22 in a predetermined order in a low subfield, the description is provided for a structure of the sequential address operation from scan electrode 22 (scan electrode SC1) at the top end of panel 10 toward scan electrode 22 (scan electrode SCn) at the bottom end of panel 10 in order. However, the present invention is not limited to this structure. For example, the address operation is sequentially performed from scan electrode 22 (scan electrode SCn) at the bottom end of panel 10 toward scan electrode 22 (scan electrode SC1) at the top end of panel 10. Alternatively, the display area is divided into two regions, and the address operation is performed from scan electrodes 22 (scan electrode SC1 and scan electrode SCn) at the top and bottom ends of panel 10, respectively, toward scan electrode 22 (scan electrode SCn/2) in the center of panel 10. “An address operation in a predetermined order” in the present invention can be an address operation in any order as long as the address operation can smooth the luminance change based on the address discharge on the image display surface of panel 10.

In this exemplary embodiment, the description is provided for the following structure. That is, the address operation is switched between the two cases: “one of subfields where the rate of the luminance weight in one field is equal to or higher than a predetermined rate, or the number of sustain pulses generated in the sustain period is equal to or larger than a predetermined number”; and “one of the subfields where the rate of the luminance weight in one field is lower than the predetermined rate, or the number of sustain pulses generated in the sustain period is smaller than the predetermined number”. However, in an image display mode, the address operation may be switched between “one of subfields where the rate of the luminance weight in one field is equal to or higher than a predetermined rate” and “one of the subfields where the rate of the luminance weight in one field is lower than the predetermined rate”. In another image display mode, the address operation may be switched between “one of subfields where the number of sustain pulses generated in the sustain period is equal to or larger than a predetermined number” and “one of the subfields where the number of sustain pulses generated in the sustain period is smaller than the predetermined number”. Alternatively, instead of the image display modes, such switching may be performed according to the values of the luminance magnification. In this case, in a plasma display device structured to change the value of the luminance magnification according to the average luminance level of a display image, such switching can be adaptively performed according to the average luminance level of the display image.

### Example 3

In the above exemplary embodiments, the description is provided for the operation of determining the order of the address operations on the respective regions according to the detected partial light-emitting rates, in driving where an initializing operation is performed only in each initializing period (hereinafter, referred to as “one-phase driving”). However, the present invention is not limited to this structure.

The wall charge formed in discharge cells by the initializing discharge in the initializing period decreases gradually with a lapse of time. For this reason, in the discharge cells undergoing the address operation later, a larger amount of wall charge decreases, which increases the scan pulse voltage (amplitude) necessary for causing a stable address discharge. Especially in high-definition panel 10, an increased number of scan electrodes 22 require a longer time for the address operation. Thus, in the discharge cells undergoing address operation in a later part of the address period, a decrease in the wall charge tends to be larger.

However, compared to the one-phase driving, the following driving method (hereinafter, referred to as “two-phase driving) can reduce the decrease in the wall charge and stabilize the address operation. In this driving method, in addition to an initializing operation at the first time in each initializing period (hereinafter, also referred to as “first initializing operation”), an initializing operation at the second time (hereinafter, also “second initializing operation”) is performed midway in each address period. That is, the address operations are performed so that each address period is divided into two periods: an address period after the first initializing operation before the second initializing operation (hereinafter, “first address period”); and an address period after the second initializing operation (hereinafter, “second address period”). In the two-phase driving, the second initializing operation is performed midway in each address period. Therefore, in the region undergoing the address operation last in the address period, i.e. the region undergoing the address operation last after the initializing operation, the lapse of time from the initializing operation to the address operation can be reduced to approximately a half of that of one-phase driving where the initializing operation is performed only in the initializing period. In the two-phase driving, similarly to the one-phase driving, not two address operations but one address operation is performed on each discharge cell in each subfield.

Hereinafter, a description is provided for an example of the two-phase driving in accordance with this exemplary embodiment.

First, driving voltage waveforms and the outline of the operation in the two-phase driving are described, with reference to the accompanying drawings. In this exemplary embodiment, one field is formed of eight subfields (the first SF, and the second SF through the eighth SF), and the respective subfields have luminance weights of 1, 2, 4, 8, 16, 32, 64, and 128. In this exemplary embodiment, an all-cell initializing operation is performed in the initializing period of the first SF, and a selective initializing operation is performed in the second SF through the eighth SF.

However, in this exemplary embodiment, the number of subfields or the luminance weights of the respective subfields is not limited to the above values. The subfield structure may be switched according to image signals, for example.

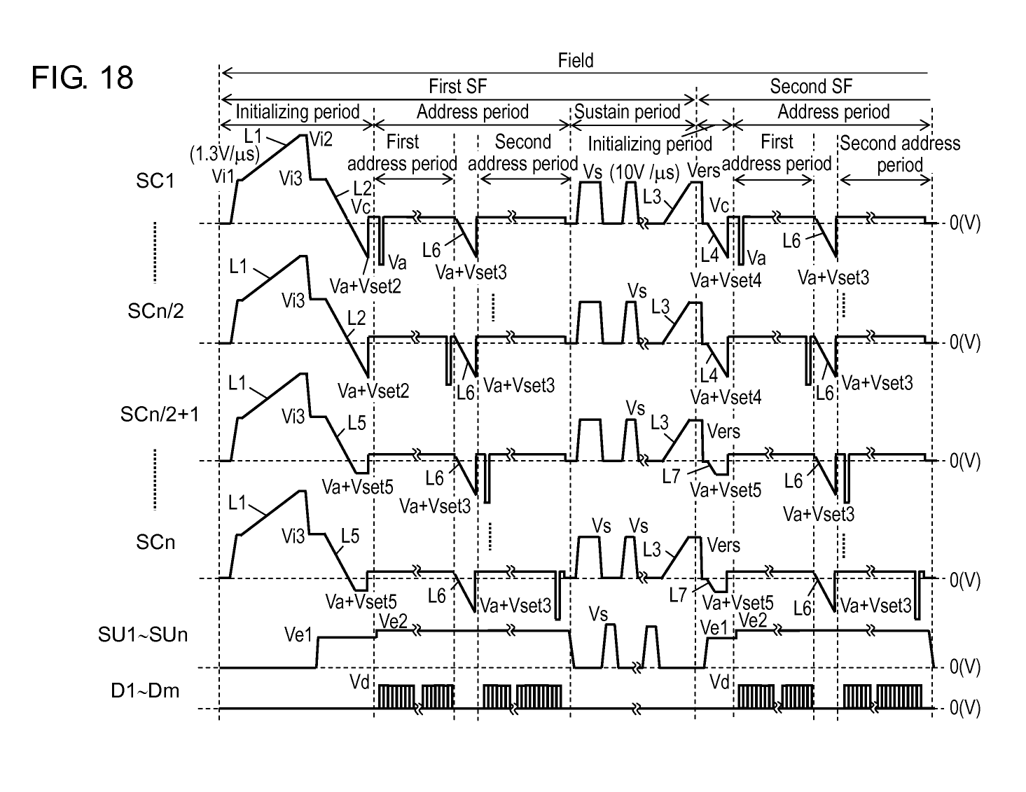

FIG. 18 is a waveform chart of driving voltages applied to the respective electrodes of panel 10 in accordance with the third exemplary embodiment of the present invention.

In this exemplary embodiment, the first address period is set after the first initializing operation in each initializing period, the second initializing operation is performed after the completion of the first address period, and the second address period is set after the completion of the second initializing operation.

In the present invention, the order of address operations on the respective regions is determined so that the time from the initializing operation to the address operation is shorter in the regions having the higher partial light-emitting rates. For this reason, in the two-phase driving of this exemplary embodiment, the order of address operations on the respective regions is different from that of the one-phase driving. This is because the second initializing operation is performed midway in each address period. This operation will be detailed later. Herein, a description is provided for a case where scan pulse voltage Va is sequentially applied from scan electrode SC1 in order. FIG. 18 shows scan electrode SC1 undergoing the address operation first in the first address period, scan electrode SCn/2 (e.g. scan electrode SC540) undergoing the address operation last in the first address period, i.e. immediately before the second initializing operation, SCn/2+1 (e.g. scan electrode SC541) undergoing the address operation first in the second address period, i.e. immediately after the second initializing operation, and scan electrode SCn (e.g. scan electrode SC1080) undergoing the address operation last in the second address period. This chart also shows driving voltage waveforms applied to sustain electrode SU1 through sustain electrode SUn, and data electrode D1 through data electrode Dm.

First, the first SF, an all-cell initializing subfield, is described.

The operation in the first half of the initializing period of the first SF is similar to the operation in the first half of the initializing period of the first SF in the driving voltage waveforms of FIG. 3, and thus the description is omitted.

In the second half of the initializing period, positive voltage Ve1 is applied to sustain electrode SU1 through sustain electrode SUn, and 0 (V) is applied to data electrode D1 through data electrode Dm.

At this time, in this exemplary embodiment, initializing waveforms having different waveform shapes are applied to the discharge cells undergoing only the first initializing operation and the discharge cells undergoing also the second initializing operation in addition to the first initializing operation. Specifically, down-ramp voltages having different minimum voltages are applied to scan electrodes 22 in the discharge cells undergoing only the first initializing operation and scan electrodes 22 in the discharge cells undergoing the first and the second initializing operations.

Down-ramp voltage L2 similar to that in the second half of the initializing period of the first SF shown in FIG. 3 is applied to scan electrodes 22 in the discharge cells undergoing only the first initializing operation (scan electrode SC1 through scan electrode SCn/2 in the example of FIG. 18). This application causes an initializing discharge between scan electrode SC1 through scan electrode SCn/2 and sustain electrode SU1 through sustain electrode SUn/2, and between scan electrode SC1 through SCn/2 and data electrode D1 through data electrode Dm. This initializing discharge reduces the negative wall voltage on scan electrode SC1 through scan electrode SCn/2 and the positive wall voltage on sustain electrode SU1 through sustain electrode SUn/2, and adjusts the positive wall voltage on data electrode D1 through data electrode Dm to a value appropriate for the address operation.

On the other hand, down-ramp voltage L5, which gradually falls from voltage Vi3 to negative voltage (Va+Vset5), is applied to scan electrodes 22 in the discharge cells undergoing the second initializing operation in addition to the first initializing operation (scan electrode SCn/2+1 through scan electrode SCn in the example of FIG. 18). At this time, voltage Vset5 is set to a voltage (e.g. 70 (V)) higher than voltage Vset2 (e.g. 6 (V)).

In this manner, in the initializing period in this embodiment, down-ramp voltage L2 falls to voltage (Va+Vset2) on scan electrodes 22 in the discharge cells undergoing only the first initializing operation. In contrast, on scan electrodes 22 in the discharge cells undergoing the first and the second initializing operations, down-ramp voltage L5 falls only to voltage (Va+Vset5), which is higher than voltage (Va+Vset2). Thus, the amount of charge that is transferred by the initializing discharge in the discharge cells applied with down-ramp voltage L5 is smaller than that in the discharge cells where the initializing discharge is caused by down-ramp voltage L2. Therefore, in the discharge cells applied with down-ramp voltage L5, wall charge more than that in the discharge cells applied with down-ramp voltage L2 remains.

In the subsequent address period, address operations are performed separately in the first address period and in the second address period. However, the address operation itself is similar to the address operation shown in the address period of FIG. 3. That is, scan pulse voltage Va is applied to scan electrodes 22, positive address pulse Vd is applied to data electrode Dk (k being 1 through m) corresponding to the discharge cell to be lit among data electrodes 32, and thus an address discharge is caused selectively in the corresponding discharge cells.

This address operation is sequentially performed on the discharge cells undergoing only the first initializing operation (scan electrode SC1 through scan electrode SC/2 in the example of FIG. 18). Thus, first, the address operation on the discharge cells undergoing only the first initializing operation is completed.

In this exemplary embodiment, after the completion of the first address period and before the start of the address operation in the subsequent second address period, a down-ramp voltage having a minimum voltage lower than that of down-ramp voltage L5, specifically down-ramp voltage L6 falling from voltage Vc toward negative voltage (Va+Vset3), is applied to scan electrodes 22 in the discharge cells undergoing the second initializing operation (scan electrodes SCn/2+1 through scan electrode SCn in the example of FIG. 18).

As described above, on scan electrodes 22 in the discharge cells undergoing the first and the second initializing operations, down-ramp voltage L5 falls only to negative voltage (Va+Vset5). Thus, in the discharge cells applied with down-ramp voltage L5, wall charge more than that in the discharge cells applied with down-ramp voltage L2 remains. Therefore, voltage Vset3 (e.g. 8 (V)) is set to a voltage sufficiently smaller than voltage Vset5 (e.g. 70 (V)), and down-ramp voltage L6 is lowered to a potential sufficiently lower than down-ramp voltage L5. Thereby, the second initializing discharge can be caused in the discharge cells applied with down-ramp voltage L5.

The wall charge formed by the initializing discharge reduces with a lapse of time. However, in the two-phase driving, the wall charge in the discharge cells undergoing the second initializing operation can be adjusted midway in the address period. Therefore, in the discharge cell undergoing the address operation latest after the initializing operation, the lapse of time from the initializing operation to the address operation can be reduced to substantially a half of that in the one-phase driving. This operation can stabilize the address operation in the discharge cells undergoing the address operation in a later part of the address period.

In the waveform chart of FIG. 18, down-ramp voltage L6 is also applied to scan electrodes 22 in the discharge cells undergoing only the first initializing operation (scan electrode SC1 through scan electrode SCn/2 in the example of FIG. 18), at the same timing at which down-ramp voltage L6 is applied to scan electrodes 22 in the discharge cells undergoing the second initializing operation (scan electrode SCn/2+1 through scan electrode SCn in the example of FIG. 18). Since the address operation on the discharge cells undergoing only the first initializing operation is already completed, down-ramp voltage L6 does not need to be applied to those discharge cells. However, when it is difficult to configure the scan electrode driving circuit so that down-ramp voltage L6 can be applied selectively, down-ramp voltage L6 may be applied to the discharge cells undergoing only the first initializing operation, as shown in FIG. 18. This is due to the following reason. In the discharge cells where the initializing discharge is caused by application of down-ramp voltage L2, no initializing discharge will be caused again by application of down-ramp voltage L6 that falls only to voltage (Va+Vset3), which is higher than minimum voltage (Va+Vset2) of down-ramp voltage L2.

After the second initializing operation has been performed by application of down-ramp voltage L6, the address operation is performed on scan electrodes 22 having undergone no address operation (scan electrode SCn/2+1 through scan electrode SCn in the example of FIG. 18), according to a procedure similar to the above. After the completion of all the above address operations, the address periods of the first SF are completed.

While down-ramp voltage L6 is applied to scan electrodes 22, no address pulse is applied to data electrode D1 through data electrode Dm.

The operations in the subsequent sustain period are similar to those in the sustain period in the driving voltage waveforms of FIG. 3, and thus the description thereof is omitted.

In the initializing period of the second SF, similar to the initializing waveforms shown in the initializing period of the second SF of FIG. 3, down-ramp voltage L4, which falls from a voltage (e.g. 0 (V)) equal to or lower than the breakdown voltage toward negative voltage (Va+Vset4), is applied to scan electrodes 22 in the discharge cells undergoing only the first initializing operation (scan electrode SC1 through electrode SCn/2 in the example of FIG. 18).

With this operation, in the discharge cells having undergone the sustain discharge in the sustain period of the preceding subfield (the first SF in the example of FIG. 18), a weak initializing discharge occurs. This discharge reduces the wall voltage on scan electrode SCi and sustain electrode SUi, and adjusts the wall voltage on data electrode Dk (k being 1 through m) to a value appropriate for the address operation. However, in the discharge cells having undergone no sustain discharge in the preceding subfield, no discharge occurs and the wall charge at the completion of the initializing period of the preceding subfield is maintained.

On the other hand, down-ramp voltage L7, which falls from a voltage (e.g. 0 (V)) equal to or lower than the breakdown voltage toward negative voltage (Va+Vset5), is applied to scan electrodes 22 in the discharge cells undergoing the second initializing operation in addition to the first initializing operation (scan electrode SCn/2+1 through scan electrode SCn in the example of FIG. 18).

With this operation, similarly to the above, a weak initializing operation occurs only in the discharge cells having undergone the sustain discharge in the preceding subfield (the first SF in FIG. 18) among the discharge cells undergoing the second initializing operation in addition to the first initializing operation. However, down-ramp voltage L7 falls only to voltage (Va+Vset5), which is higher than voltage (Va+Vset2). Thus, in the discharge cells applied with down-ramp voltage L7, the amount of charge transferred by the initializing discharge is smaller than that in the discharge cells where an initializing discharge is caused by down-ramp voltage L4. For this reason, in the discharge cells applied with down-ramp voltage L7, wall charge more than that in the discharge cells applied with down-ramp voltage L4 remains.

In the address periods of the second SF, driving waveforms similar to those of the address periods of the first SF are applied to the respective electrodes. That is, the address operation is performed on the discharge cells applied with down-ramp voltage L4, and thereafter the second initializing operation is performed by down-ramp voltage L6 on the discharge cells applied with down-ramp voltage L7. Subsequently, the address operation is performed on the discharge cells having undergone the second initializing operation.

The operations in the sustain period of the second SF are similar to those in the sustain period of the first SF, and thus the description thereof is omitted. In the third SF and thereafter, the driving voltage waveforms similar to those in the second SF except for the numbers of sustain pulses in the sustain periods are applied to scan electrode SC1 through scan electrode SCn, sustain electrode SU1 through sustain electrode SUn, and data electrode D1 through data electrode Dm.

In the above structure, it is preferable to set voltage Vset2 in down-ramp voltage L2 smaller than voltage Vset4 (e.g. 10 (V)) in down-ramp voltage L4. This is because setting voltage (Va+Vset2) smaller than voltage (Va+Vset4) ensures occurrence of the initializing discharge in the first SF, i.e. the first initializing discharge in one field period.

The above description has outlined the driving voltage waveforms applied to the respective electrodes of panel 10 in the two-phase driving in this exemplary embodiment. Next, the advantage offered by the two-phase driving is described.

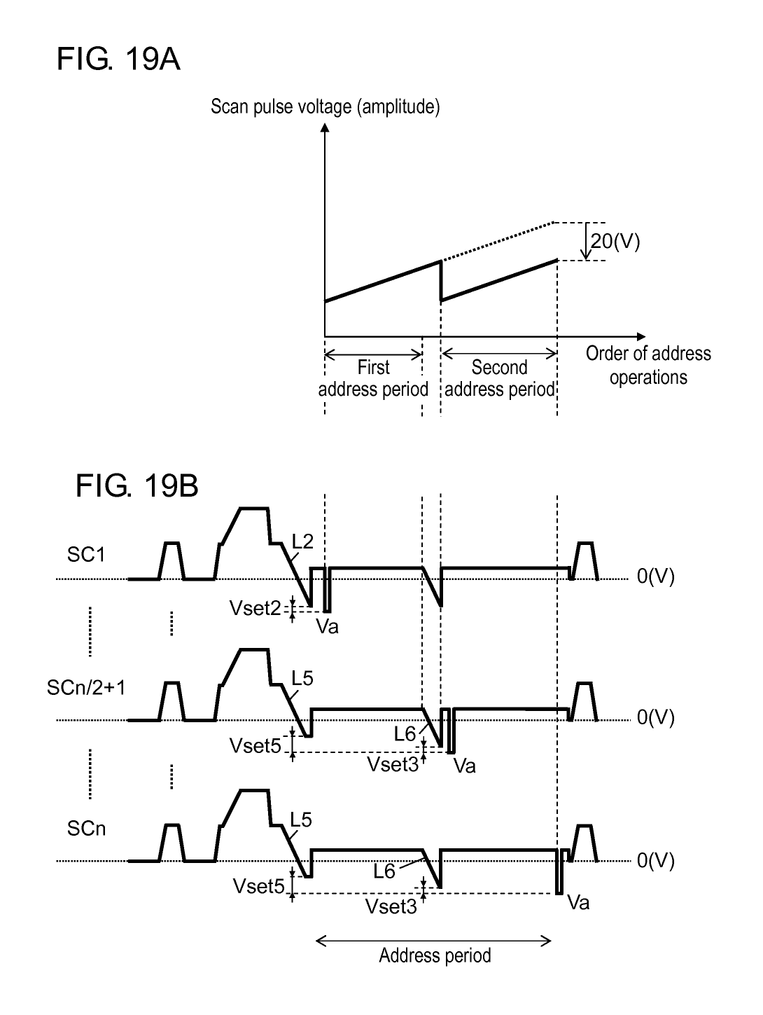

FIG. 19 is a diagram schematically showing the relation between a scan pulse voltage (amplitude) necessary for causing a stable address discharge and an order of address operations, and driving voltage waveforms applied to scan electrode SC1 through scan electrode SCn in the two-phase driving in accordance with the third exemplary embodiment. In FIG. 19, one diagram includes a characteristics chart (upper chart of FIG. 19) schematically showing the relation between a scan pulse voltage (amplitude) necessary for causing a stable address discharge and the order of address operations, and a waveform chart (lower chart of FIG. 19) showing driving voltage waveforms applied to scan electrode SC1 through scan electrode SCn). This is to facilitate understanding of the timing relation between changes in the driving voltage waveforms and the scan pulse voltage (amplitude) necessary for causing a stable address discharge.

In the upper chart of FIG. 19, i.e. the characteristics chart schematically showing the relation between the scan pulse voltage (amplitude) necessary for causing a stable address discharge and the order of address operations, the horizontal axis shows the order of address operations on scan electrode SC1 through scan electrode SCn, and the vertical axis shows the scan pulse voltage (amplitude) necessary for causing a stable address operation in each discharge cell.

The lower chart of FIG. 19, i.e. the waveform chart showing the driving voltage waveforms applied to scan electrode SC1 through scan electrode SCn, shows driving voltage waveforms applied to scan electrode 22 undergoing the address operation first in the first address period (scan electrode SC1 in the example of FIG. 19), scan electrode 22 undergoing the address operation first in the second address period (scan electrode SCn/2+1 in the example of FIG. 19), and scan electrode 22 undergoing address operation last in the second address period (scan electrode SCn in the example of FIG. 19).

FIG. 19 shows, in the form of a graph, the detection result of experiments conducted under the following conditions: an address operation is sequentially performed on scan electrode SC1 through scan electrode SCn, and a second initializing operation is performed between the address operation on scan electrode SCn/2 and the address operation on scan electrode SCn/2+1. The characteristics chart of FIG. 19 shows the relation between the scan pulse voltage (amplitude) necessary for causing a stable address discharge and the lapse of time after the initializing operation in the form of a graph. Scan pulse voltage Va is not changed for each scan electrode. In the characteristics chart of FIG. 19, for comparison with the advantage of the two-phase driving, the scan pulse voltage (amplitude) necessary for causing a stable address discharge in one-phase driving is shown by the broken line.

In the two-phase driving of this exemplary embodiment, an initializing discharge is caused by down-ramp voltage L6 on the discharge cells having undergone no address operation yet, midway in each address period (immediately before the address operation on scan electrode SCn/2+1 in the waveform chart of FIG. 19). This operation can reduce the scan pulse voltage (amplitude) necessary for causing a stable address discharge in the discharge cells undergoing the second initializing operation, as shown by the solid line in the characteristics chart of FIG. 19. In the experiments, it is verified that the two-phase driving can make the scan pulse voltage (amplitude) necessary for causing a stable address discharge in the discharge cell undergoing the address operation last in the address period approximately 20 (V) lower than that of the one-phase driving.

In the present invention, the order of the address operations on the respective regions is determined so that the regions having the higher partial light-emitting rates have the shorter time from the initializing operation to the address operation. For this reason, the order of the address operations in the two-phase driving is different from that in the one-phase driving. Next, a specific example thereof is described.

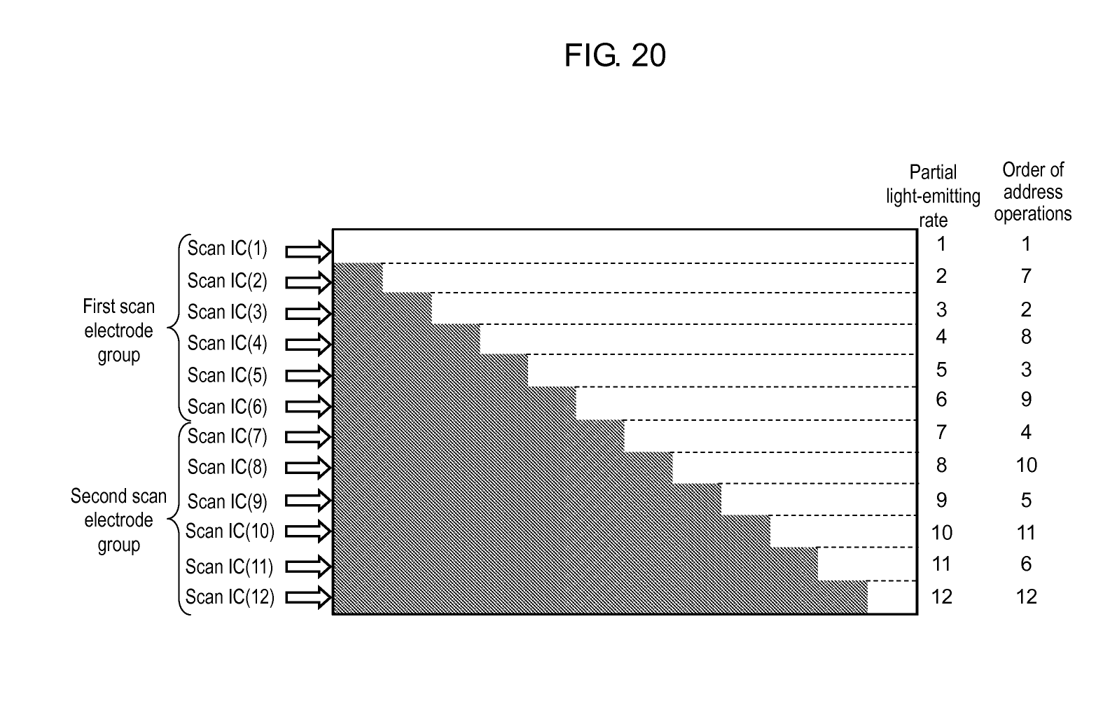

FIG. 20 is schematic diagram showing an example of a scanning order (an example of order of address operations of scan ICs) based on partial light-emitting rates when a predetermined image is displayed by the two-phase driving in accordance with the third exemplary embodiment. In FIG. 20, the diagonally shaded regions show the distribution of unlit cells, and the outline regions that are not diagonally shaded show the distribution of lit cells. In FIG. 20, the boundaries of the regions are shown by the broken lines to clarify each region.

In the example of FIG. 20, the region having the highest partial light-emitting rate is region (1) connected to scan IC (1). The partial light-emitting rates in the other regions decrease in the following order: region (2), region (3), region (4), region (5), region (6), region (7), region (8), region (9), region (10), region (11), and region (12).

Therefore, when this image is displayed by the one-phase driving, the address operation is performed on the respective regions in the following order: region (1), region (2), region (3), region (4), region (5), region (6), region (7), region (8), region (9), region (10), region (11), and region (12).

However, in the two-phase driving of this exemplary embodiment, as shown in FIG. 20, for example, the address operation is performed on region (1) having the highest partial light-emitting rate after the first initializing operation. Thereafter, the address operation is sequentially performed on every other region in decreasing order of partial light-emitting rates as follows: region (3) having the third highest partial light-emitting rate; region (5) having the fifth highest partial light-emitting rate; region (7) having the seventh highest partial light-emitting rate; region (9) having the ninth highest partial light-emitting rate; and region (11) having the eleventh highest partial light-emitting rate. Then, after the second initializing operation, the address operation is sequentially performed on the remaining regions in decreasing order of partial light-emitting rates as follows: region (2) having the second highest partial light-emitting rate; region (4) having the fourth highest partial light-emitting rate; region (6) having the sixth highest partial light-emitting rate; region (8) having the eighth highest partial light-emitting rate; region (10) having the tenth highest partial light-emitting rate; and region (12) having the lowest partial light-emitting rate.

With this structure, the address operation can be performed not only on region (1) having the highest partial light-emitting rate but also on region (2) having the second highest partial light-emitting rate immediately after initializing operations. Further, the lapse of time from the initializing operation to the address operation on region (12) having the lowest partial light-emitting rate and region (11) having the second lowest partial light-emitting rate can be reduced to substantially a half of that in the one-phase driving.

In the two-phase driving, the second initializing operation is performed midway in each address period. Therefore, as shown in FIG. 20, after the first initializing operation, the address operation is sequentially performed on every other region starting from the region having the highest partial light-emitting rate. Then, after the second initializing operation, the address operation can be sequentially performed on the remaining regions in decreasing order of partial light-emitting rates. In addition to the advantage of the first exemplary embodiment, i.e. stabilizing the address discharge by performing the address operation so that the regions having the higher partial light-emitting rates have the shorter lapse of time from the initializing operation to the address operation, the following advantage can be offered. This two-phase driving can provide more regions having the shortened lapse of time from the initializing operation to the address operation than the one-phase driving, and thus causing the address discharge more stably.

The order of address operations on the respective regions in the two-phase driving is not limited to the order shown in FIG. 20. In the structure described in this exemplary embodiment, the address operation on the region having the highest partial light-emitting rate is performed immediately after the first initializing operation, and the address operation on the region having the second highest partial light-emitting rate is performed immediately after the second initializing operation. However, in the present invention, the address operation on the respective regions may be performed in the order such that the lapse of time from the initializing operation to the address operation is shorter in the regions having the higher partial light-emitting rates.

Therefore, when the order of the partial light-emitting rates of the respective regions is as shown in FIG. 20, the following order other than the order of address operations shown in FIG. 20 may be used. For example, after the first initializing operation, the address operation is performed on region (2), region (4), region (6), region (8), region (10), and region (12) in this order. Then, after the subsequent second initializing operation, the address operation is performed on region (1), region (3), region (5), region (7), region (9), and region (11) in this order. Alternatively, after the first initializing operation, the address operation is performed on region (1), region (4), region (5), region (8), region (9), and region (12) in this order. Then, after the subsequent second initializing operation, the address operation is performed on region (2), region (3), region (6), region (7), region (10), and region (11) in this order.

Alternatively, after the first initializing operation, the address operation is performed on region (2), region (3), region (6), region (7), region (10), and region (11) in this order. Then, after the subsequent second initializing operation, the address operation is performed on region (1), region (4), region (5), region (8), region (9), and region (12) in this order.

Even in such an order, the structure of the present invention, i.e. the structure where the order of address operations on the respective regions is determined so that the regions having the higher light-emitting rates have the shorter time from the initializing operation to the address operation, can be implemented.

The two-phase driving may be performed in all the subfields. However, the two-phase driving requires more driving time than the one-phase driving by the increased number of initializing operations. Therefore, when sufficient driving time is not allowed, the subfields for two-phase driving may be limited in the following manner: the two-phase driving is performed only in the subfields having large luminance weights, and the one-phase driving is performed in the subfields having small luminance weights, for example. In this case, the order of address operations may be determined optimally for the one-phase driving or the two-phase driving.

In this exemplary embodiment, the description is provided for an example of two-phase driving where the second initializing operation is performed in each address period. However, for example, three-phase driving where the second and the third initializing operations are performed in each address period, or multi-phase driving where more initializing operations are performed may be used. In these structures, the address operation on the region having the highest partial light-emitting rate is performed immediately after an initializing operation, the address operation on the region having the second highest partial light-emitting rate is performed immediately after another initializing operation, and the address operation on the region having the third highest partial light-emitting rate is performed immediately after another initializing operation. In this manner, the order of address operations is set according to the idea similar to the above.

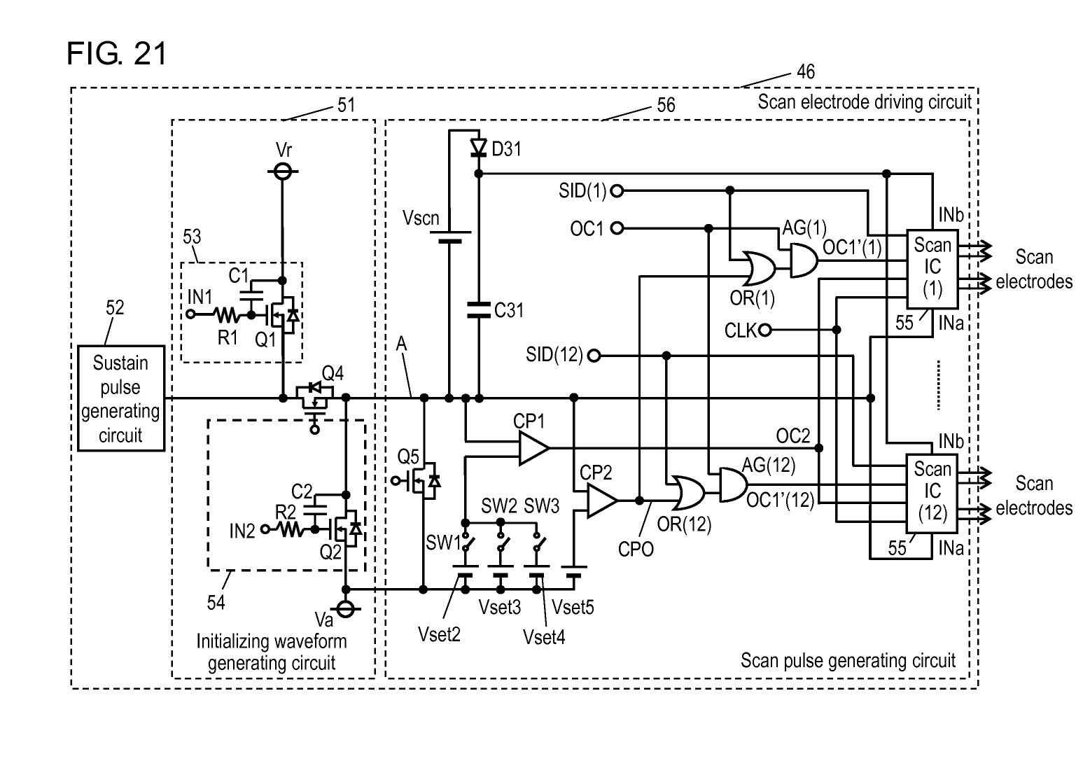

Next, a description is provided for scan electrode driving circuit 49. FIG. 21 is a circuit diagram of scan electrode driving circuit 49 in accordance with the third exemplary embodiment of the present invention. Scan electrode driving circuit 49 has the following elements:
sustain pulse generating circuit 52 for generating sustain pulses;
initializing waveform generating circuit 51 for generating initializing waveforms; and
scan pulse generating circuit 56 for generating scan pulses.
   The respective outputs of scan pulse generating circuit 56 are connected to scan electrode SC1 through scan electrode SCn of panel 10. FIG. 21 shows a separating circuit having switching element Q4, for electrically separating sustain pulse generating circuit 52 and a circuit based on voltage Vr (e.g. Miller integrating circuit 53) from a circuit based on negative voltage Va (e.g. Miller integrating circuit 54) while this circuit is operated.

Sustain pulse generating circuit 52 is configured and operates in a similar manner to sustain pulse generating circuit 52 of the first exemplary embodiment. The sustain pulse generating circuit has a generally-used power recovery circuit and clamp circuit (both not shown), and generates sustain pulses by switching the respective switching elements inside thereof according to control signals output from timing generating circuit 45. The sustain pulse generating circuit 52 also has a Miller integrating circuit (not shown) for generating a rising ramp voltage, and generates erasing ramp voltage L3 at the end of each sustain period.

Initializing waveform generating circuit 51 is configured and operates in a similar manner to initializing waveform generating circuit 51 of the first exemplary embodiment. The initializing waveform generating circuit has the following elements:
Miller integrating circuit 53 having switching element Q1, capacitor C1, and resistor R1, for causing reference potential A of scan pulse generating circuit 56 to rise in a ramp form; and
Miller integrating circuit 54 having switching element Q2, capacitor C2, and resistor R2, for causing reference potential A of scan pulse generating circuit 56 to fall in a ramp form.
   Miller integrating circuit 53 generates a ramp voltage rising in the initializing operation; Miller integrating circuit 54 generates a ramp voltage falling in the initializing operation. FIG. 21 shows the input terminal of Miller integrating circuit 53 as input terminal IN1, and the input terminal of Miller integrating circuit 54 as input terminal IN2. Reference potential A is a potential in the path connected to input terminal INa on the low voltage side of each of scan ICs 55, which will be describe later.

In this exemplary embodiment, initializing waveform generating circuit 51 is formed of FET-based Miller integrating circuits that are practical and have relatively simple configurations. However, this exemplary embodiment is not limited to this configuration. Any circuit may be used as long as the circuit is capable of causing reference potential A to rise or fall in a ramp form.

Scan pulse generating circuit 56 has the following elements:
a plurality of scan ICs 55 (scan IC (1) through scan IC (12) in this exemplary embodiment) for outputting a scan pulse to scan electrode SC1 through scan electrode SCn;
switching element Q5 for connecting reference potential A to negative voltage Va in address periods;
diode D31 and capacitor C31 for applying voltage Vc where voltage Vscn is superimposed on reference potential A to the high voltage side (input terminal INb) of each scan IC 55;
comparator CP1 and comparator CP2 each for comparing the magnitudes of the input signals input to two input terminals thereof;
switching element SW1 for applying voltage (Va+Vset2) to one of the input terminals of comparator CP1;
switching element SW2 for applying voltage (Va+Vset3) to the one of the input terminals of comparator CP1;
switching element SW3 for applying voltage (Va+Vset4) to the one of the input terminals of comparator CP1;
OR gates OR (OR gate OR (1) through OR gate OR (12) in this exemplary embodiment) for performing OR operations on control signals SIDs (control signals SID (1) through control signals SID (12) in this exemplary embodiment) that control scan ICs 55 (scan IC (1) through scan IC (12) in this exemplary embodiment) and output signal CPO from comparator CP2; and
AND gates AG (AND gate AG (1) through AND gate AG (12) in this exemplary embodiment) for performing AND operations on control signal OC1 for controlling scan ICs 55 (scan IC (1) through scan IC (12) in this exemplary embodiment) and the output signals from OR gates OR (OR gate OR (1) through OR gate OR (12)).
   The other of the input terminals of comparator CP1 is connected to reference potential A. One of the input terminals of comparator CP2 is connected to voltage (Va+Vset 5); the other of the input terminals of comparator CP2 is connected to reference potential A. Each of the number of OR gates OR and the number of AND gates AG is equal to the number of scan ICs 55 (12 in this exemplary embodiment).

Each scan IC 55 has two input terminals: input terminal INa, i.e. the input terminal on the low voltage side; and input terminal INb, i.e. the input terminal on the high voltage side. Each scan IC also has a plurality of output terminals connected to corresponding scan electrodes 22. In response to control signals, the scan IC outputs either one of the voltages input to the two input terminals. As control signals, the following signals are input to each of scan ICs 55 (scan IC (1) through scan IC (12) in this exemplary embodiment). They are control signals OC1′ (control signal OC1′ (1) through control signal OC1′ (12) in this exemplary embodiment) output from AND gates AG (AND gate AG (1) through AND gate AG (12) in this exemplary embodiment), and control signal OC2 output from comparator CP1, and scan start signals SIDs (scan start signal SID (1) through scan start signal SID (12) in this exemplary embodiment) output from timing generating circuit 45 in the address periods. Control signal OC2 is a control signal input to all scan ICs 55 in common. Clock signal CLK, i.e. a synchronizing signal for synchronizing signal processing operation, is input to all scan ICs 55.

In this exemplary embodiment, the order of the address operations of scan ICs 55 is changed according to the detected partial light-emitting rates. Therefore, according to the change, the shape of the initializing waveform applied to scan ICs 55 needs to be changed. In this exemplary embodiment, the shape of the initializing waveform applied to scan ICs 55 can be set optionally by configuring scan pulse generating circuit 56 as shown in FIG. 21. Next, the operation of this scan pulse generating circuit 56 is described.

Scan pulse generating circuit 56 is controlled by timing generating circuit 45 so as to output the voltage waveform from initializing waveform generating circuit 51 in initializing periods and output the voltage waveform from sustain pulse generating circuit 52 in sustain periods.

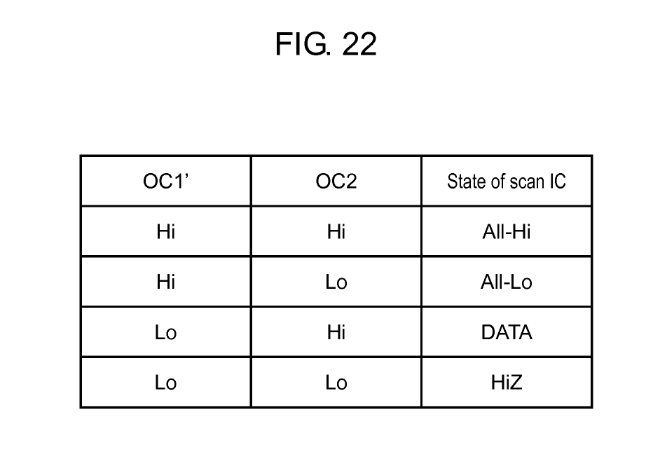

First, the operation of scan ICs 55 is described. FIG. 22 is a chart for explaining the correlation between control signal OC1′ and control signal OC2 and the operation state of scan IC 55 in accordance with the third exemplary embodiment.

As shown in FIG. 22, when control signal OC1′ and control signal OC2 are both at a high level (hereinafter, referred to as “Hi”), scan IC 55 is in “All-Hi” state, i.e. a state where all the output terminals of scan IC 55 are electrically connected to input terminal INb on the high voltage side.

When control signal OC1′ is at “Hi” and control signal OC2 is at a low level (hereinafter, “Lo”), scan IC 55 is “All-Lo” state, i.e. a state where all the output terminals of scan IC 55 are electrically connected to input terminal INa on the low voltage side. For example, when sustain pulse generating circuit 52 is operated, control signals OC1′ are set to “Hi” and control signal OC 2 is set to “Lo”, so that switching element QH1 through switching element QHn are set to OFF and switching element QL1 through switching element QLn are set to ON. Thereby, the sustain pulses output from scan pulse generating circuit 52 can be applied to scan electrode SC1 through scan electrode SCn via switching element QL1 through switching element QLn, respectively.

When control signal OC1′ and control signal OC2 are both at “Lo”, the output terminal of scan IC 55 is in a high impedance state (hereinafter, “HiZ”.

When control signal OC1′ is at “Lo” and control signal OC2 is at “Hi”, scan IC 55 is in “DATA” state, i.e. a state where a predetermined series of operations are performed according to scan start signal SID input to scan IC 55.

Specifically, when scan start signal SID is input to scan IC 55 (when scan start signal SID is kept at “Lo” for a predetermined period in this exemplary embodiment), first, only the first output terminal of scan IC 55 in electrically connected to input terminal INa on the low voltage side, and all the remaining output terminals except the first output terminal are electrically connected to input terminal INb on the high voltage side. After the state has been kept for a predetermined period (e.g. 1 μsec), next, only the second output terminal of scan IC 55 is electrically connected to input terminal INa on the low voltage side, and all the remaining output terminals except the second output terminal are electrically connected to input terminal INb on the high voltage side. In this manner, the respective output terminals of scan IC 55 are electrically connected to input terminal INa on the low voltage side for a predetermined period in order. In this exemplary embodiment, scan pulse voltage Va is generated sequentially in the above operation state of scan ICs 55 in address periods, so that the address operation is performed on scan electrode SC1 through scan electrode SCn.

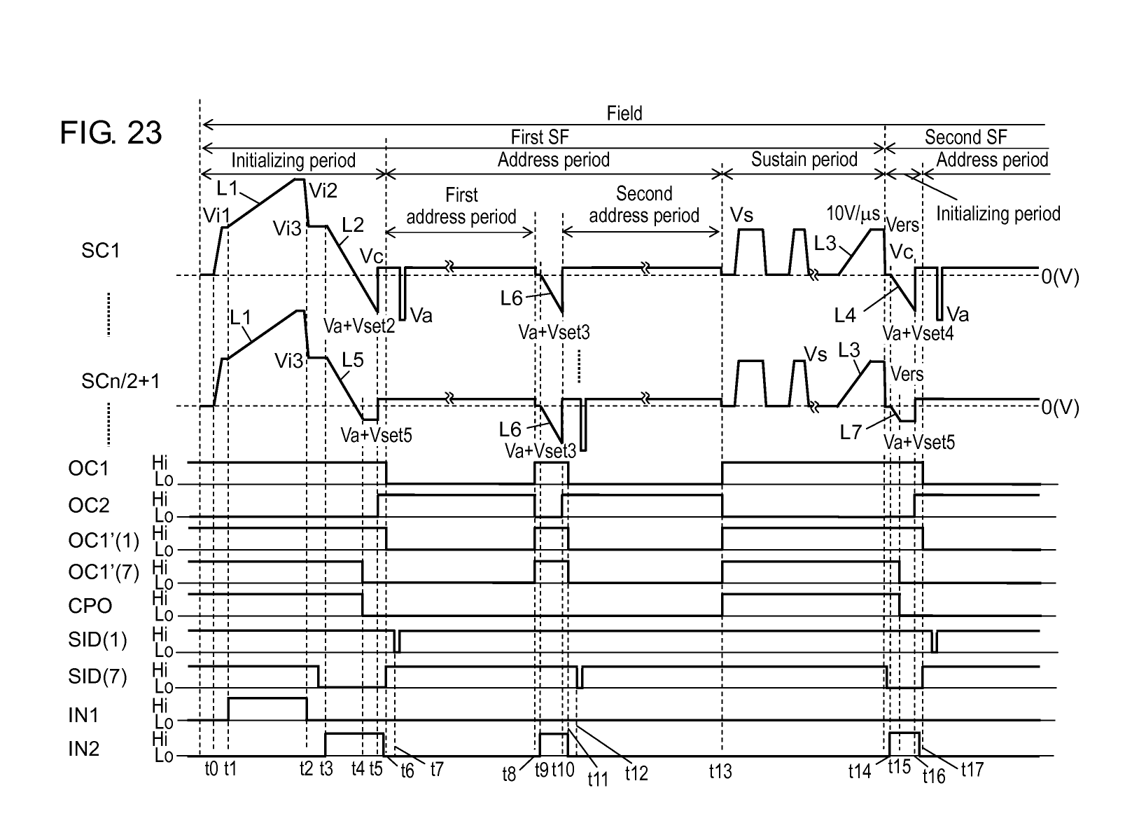

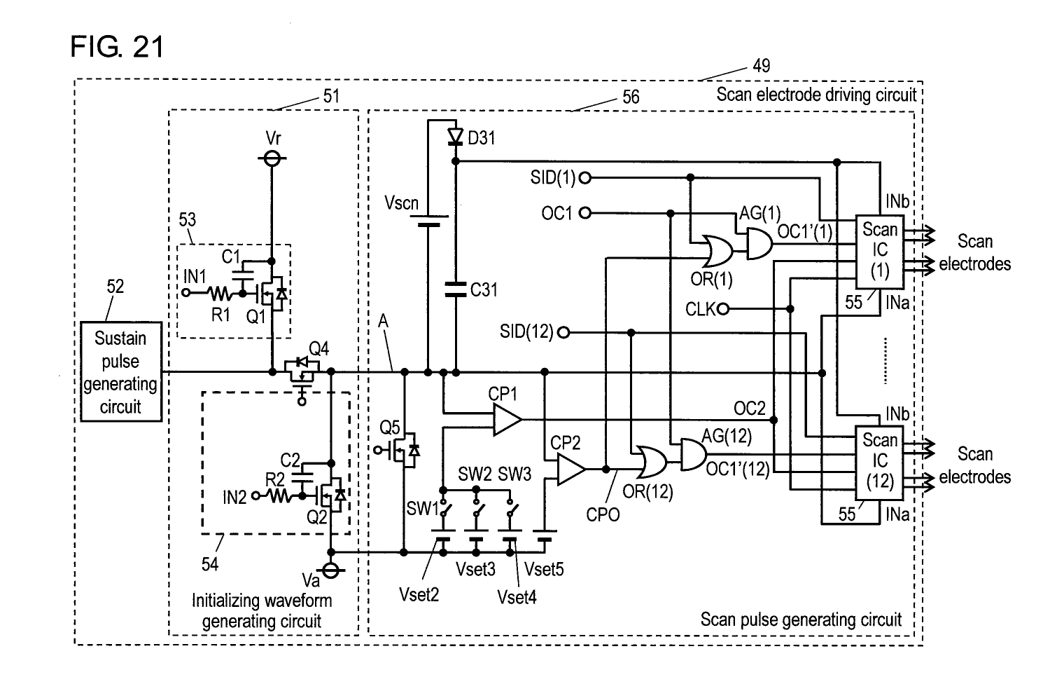

Next, the operation of scan electrode driving circuit 49 is described. FIG. 23 is a timing chart for explaining an example of the operation of scan electrode driving circuit 49 in accordance with the third exemplary embodiment. In the description with reference to FIG. 23, voltage Vi1 and voltage Vi3 are equal to voltage Vs, and voltage Vi2 is equal to voltage Vr. FIG. 23 shows a timing chart in the following case. Immediately after the first initializing operation, i.e. at the beginning of the address period, scan IC (1) is caused to perform the address operation. Thereafter, scan IC (2), scan IC (3), scan IC (4), scan IC (5), and scan IC (6) are caused to sequentially perform the address operation in this order. Next, immediately after the second initializing operation, scan IC (7) is caused to perform the address operation. Thereafter, scan IC (8), scan IC (9), scan IC (10), scan IC (11), and scan IC (12) are caused to sequentially perform the address operation in this order. FIG. 23 shows a driving voltage waveform that is applied to scan electrode SC1 undergoing the address operation first in the first address period, and a driving voltage waveform that is applied to scan electrode SCn/2+1 (e.g. scan electrode SC541) undergoing the address operation immediately after the second initializing operation, i.e. at the beginning of the second address period. The timing chart also shows the following signals necessary for controlling scan IC (1) and scan IC (7), and the states of constant current supply to input terminal IN1 and input terminal IN2. The signals are control signals, such as control signal OC1, control signal OC2, control signal OC1′ (1), control signal OC1′ (7), output signal CPO from comparator CP2, scan start signal SID (1), and scan start signal SID (7).

In this exemplary embodiment, scan IC 55 is caused to start the address operation by setting the scan start signal to “Lo” for a predetermined period (e.g. one cycle of clock signal CLK) in “DATA” state. Further, in the first halves of the initializing periods (while up-ramp voltage L1 is generated) and in the sustain periods, switching element Q4 is set to ON. In the second halves of the initializing periods (while down-ramp voltage L2 is generated) and in the address periods, switching element Q4 is set to OFF.

### (Initializing Period)

In the initializing period, first, control signal OC1 and control signal SID (1) through control signal SID (12) are set to “Hi”. At the same time, the clamp circuit of sustain pulse generating circuit 52 is operated so as to set the potential of reference potential A to 0 (V). Because 0 (V) of reference potential A is higher than any of voltage (Va+Vset2), voltage (Va+Vset3), and voltage (Va+Vset4), control signal OC2 output from comparator CP1 is at “Lo”. Further, because both control signal OC1 and control signal SID (1) through control signal SID (12) are at “Hi”, control signal OC1′ (1) through control signal OC1′ (12) output from AND gate AG (1) through AND gate AG (12) are also at “Hi”. Thus, all scan ICs 55 are in “All-Lo” state, and 0 (V) as reference potential A is the output voltage of scan ICs 55.

Next, at time t0, the power recovery circuit of sustain pulse generating circuit 52 is operated so as to cause the potential of reference potential A to rise. Thereafter, the clamp circuit of sustain pulse generating circuit 52 is operated so as to set the potential of reference potential A to voltage Vs (equal to voltage Vi1 in this exemplary embodiment).

Next, at time t1, input terminal IN1 of Miller integrating circuit 53 for generating up-ramp voltage L1 is set to “Hi”. Specifically, a predetermined constant current is input to input terminal IN1. Then, a constant current flows from resistor R1 toward capacitor C1, the source voltage of switching element Q1 rises in a ramp form, and the output voltage of initializing waveform generating circuit 51 starts to rise in a ramp form. This voltage rise continues while input terminal IN1 is at “Hi”.

After this output voltage has risen to voltage Vr (equal to voltage Vi2 in this exemplary embodiment), at time t2, input terminal IN1 is set to “Lo”. Specifically, 0 (V), for example, is applied to input terminal IN1. When input terminal IN1 is set to “Lo”, the potential of reference potential A falls to voltage Vs (equal to voltage Vi3 in this exemplary embodiment).

During this period, control signal OC1, and control signal SID (1) through control signal SID (12) are kept at “Hi”. Therefore, control signal OC1′ (1) through control signal OC1′ (12) output form AND gates AG are at “Hi”. Further, though not shown, switching element SW2 and switching element SW3 are set to OFF and switching element SW1 is set to ON so that voltage (Va+Vset2) is generated and reference potential A, i.e. the driving voltage output from initializing waveform generating circuit 51, is compared to voltage (Va+Vset2) in comparator CP1. During this period, reference potential A is higher than voltage (Va+Vset2), and thus control signal OC2 output from comparator CP1 is at “Lo”.

That is, since control signal OC1′ (1) through control signal OC1′ (12) are at “Hi” and control signal OC2 is at “Lo”, all scan ICs 55 are in “All-Lo” state. Thus, the output terminals of all scan ICs 55 output reference potential A, i.e. the driving voltage output from initializing waveform generating circuit 51 without change.

In this manner, up-ramp voltage L1, which gradually rises from voltage Vs equal to or lower than a breakdown voltage (equal to voltage Vi1 in this exemplary embodiment) to voltage Vr exceeding the breakdown voltage (equal to voltage Vi2 in this exemplary embodiment), is applied to scan electrode SC1 through scan electrode SCn.

Next, at time t3, a predetermined constant current is input to input terminal IN2 of Miller integrating circuit 54 for generating a down-ramp voltage so that input terminal IN2 is set to “Hi”. Then, a constant current flows from resistor R2 toward capacitor C2, the drain voltage of switching element Q2 falls in a ramp form, the potential of reference potential A falls in a ramp form, and the output voltage of scan ICs 55 starts to fall in a ramp form.

At this time, control signals SIDs that control scan ICs 55 for outputting down-ramp voltage L2 are kept at “Hi”. For example, when scan IC (1) through scan IC (6) are caused to output down-ramp voltage L2, control signal SID (1) through control signal SID (6) are kept at “Hi”. Thus, control signal OC1′ (1) through control signal OC1′ (6) are kept at “Hi”.

In comparator CP1, the voltage of reference potential A, i.e. the down-ramp voltage, is compared to voltage (Va+Vset2). The output signal from comparator CP1, i.e. control signal OC2, changes from “Lo” to “Hi” at time t5 when the down-ramp voltage at reference potential A becomes equal to or lower than voltage (Va+Vset2).

Thus, both control signals OC1′ (e.g. control signal OC1′ (1) through control signal OC1′ (6)) that control scan ICs 55 for outputting down-ramp voltage L2 (e.g. scan IC (1) through scan IC (6)), and control signal OC2 are at “Hi” at time t5. Thus, scan ICs 55 for outputting down-ramp voltage L2 can be brought into “All-Hi” state. Therefore, at time t5, the voltage that is output from scan ICs 55 for outputting down-ramp voltage L2 is equal to the voltage input to input terminal INb, i.e. voltage Vc where voltage Vscn is superimposed on reference potential A. As a result, the voltage drop changes to voltage rise at time t5. With this operation, down-ramp voltage L2 can be output from scan ICs 55 for outputting down-ramp voltage L2. For example, down-ramp voltage L2 having a minimum voltage of voltage (Va+Vset2) can be applied to scan electrode SC1 through scan electrode SCn/2.

On the other hand, control signals SIDs that control scan ICs 55 for outputting down-ramp voltage L5 are changed from “Hi” to “Lo” before time t3. For example, when scan IC (7) through scan IC (12) are caused to output down-ramp voltage L5, control signal SID (7) through control signal SID (12) are changed from “Hi” to “Lo” before time t3. Thus, from OR gate OR (7) through OR gate OR (12), signal CPO output from comparator CP2 is output. From AND gate AG (7) through AND gate AG (12), signal CPO is output as control signal OC1′ (7) through control signal OC1′ (12).

Because comparator CP2 compares reference potential A with voltage (Va+Vset5), signal CPO output from comparator CP2 changes from “Hi” to “Lo” at time t4 when reference potential A becomes equal to or lower than voltage (Va+Vset5).

With this operation, at time t4, control signals OC1′ (e.g. control signal OC1′ (7) through control signal OC1′ (12)) that control scan ICs 55 for outputting down-ramp voltage L5 (e.g. scan IC (7) through scan IC (12)) can be changed from “Hi” to “Lo”.

That is, both control signals OC1′ that control scan ICs 55 for outputting down-ramp voltage L5 and control signal OC2 are at “Lo” at time t4. Thus, scan ICs 55 for outputting down-ramp voltage L5 can be brought into “HiZ” state. Therefore, the output voltage of scan ICs 55 for outputting down-ramp voltage L5 is a voltage where the output voltage at time t4 is maintained. For example, down-ramp voltage L5 having a minimum voltage of voltage (Va+Vset5) can be applied to scan electrode SCn/2+1 through scan electrode SCn.

Incidentally, the scan start signal is effective only when Scan ICs 55 are in “DATA” state. Thus, even when scan start signal SID (7) becomes “Lo” in the initializing period, no influence is exerted on the operation of scan IC (7) through scan IC (12).

Then, at time t6 before the completion of the initializing period, 0 (V), for example, is applied to input terminal IN2 so as to set input terminal IN2 to “Lo”.

In the above manner, in scan electrode driving circuit 49, down-ramp voltage L2, which falls from voltage Vi3 toward voltage (Va+Vset2), is output from scan ICs 55 for outputting down-ramp voltage L2 (e.g. scan IC (1) through scan IC (6)). Thereby, down-ramp voltage L2 is applied to scan electrodes 22 that are to undergo the address operation in the period from the first initializing operation to the second initializing operation (e.g. scan electrode SC1 through scan electrode SCn/2).

On the other hand, down-ramp voltage L5, which falls from voltage Vi3 toward voltage (Va+Vset5), is output from scan ICs 55 for outputting down-ramp voltage L5 (e.g. scan IC (7) through scan IC (12)). Thereby, down-ramp voltage L5 is applied to scan electrodes 22 that are to undergo the address operation after the second initializing operation (e.g. scan electrode SCn/2+1 through scan electrode SCn). In this manner, the initializing period is completed.

### (Address Period)

Though not shown, in the address period, switching element Q5 is set to ON so that reference potential A is kept at negative voltage Va. Further, switching element SW1 and switching element SW3 are set to OFF, and switching element SW2 is set to ON so that voltage (Va+Vset3) is generated and reference potential A. i.e. negative voltage Va, is compared to voltage (Va+Vset3) in comparator CP1. Because the potential of reference potential A is lower than voltage (Va+Vset3) in this period, control signal OC2 output from comparator CP1 is at “Hi”.

At time t6, control signal OC1 is set to “Lo”. Therefore, control signals OC1′ (e.g. control signal OC1′ (1) through control signal OC1′ (12)) output from AND gates AG (e.g. AND gate AG (1) through AND gate AG (12)) also become “Lo”. With this operation, all scan ICs 55 are brought into “DATA” state, where an address operation is started in response to scan start signals.

In the first address period, first, a scan pulse is sequentially applied to scan electrodes 22 that are to undergo the address operation in the period from the first initializing operation to the second initializing operation (e.g. scan electrode SC1 through scan electrode SCn/2). For example, after the first initializing operation, scan IC (1), scan IC (2), scan IC (3), scan IC (4), scan IC (5), and scan IC (6) are caused to perform the address operation in this order. In this case, at time t7 immediately after the start of the first address period, scan start signal SID (1) is set to “Lo” for a predetermined period (e.g. one cycle of clock signal CLK). Then, scan IC (1) starts the address operation, and the scan pulse is sequentially applied to scan electrodes 22 connected to scan IC (1) (from scan electrode SC1 in this case).

Next, at a timing at which the address operation on all scan electrodes 22 connected to scan IC (1) is completed, scan start signal SID (2) is set to “Lo” for a predetermined period (e.g. one cycle of clock signal CLK). Then, scan IC (2) starts the address operation. Thereafter, in a similar manner, scan start signal SID (3) through scan start signal SID (6) are set to “Lo” for a predetermined period. In this manner, the address operation is sequentially performed on scan IC (1) through scan IC (6) so that the scan pulse is applied to scan electrode SC1 through scan electrode SCn/2.

Next, at time t8, control signal OC1 is set to “Hi”. Because scan start signals SIDs (e.g. scan start signal SID (1) through scan start signal SID (12)) are kept at “Hi”, control signals OC1′ (e.g. control signal OC1′ (1) through control signal OC1′ (12)) output from AND gates AG are also at “Hi”. Though not shown, at time t8, switching element Q5 is set to OFF, the clamp circuit of sustain pulse generating circuit 52 is operated, and reference potential A is set to 0 (V).

With this operation, the potential of reference potential A becomes higher than voltage (Va+Vset2), and control signal OC2 output from comparator CP1 becomes “Lo”. That is, control signals OC1′ (e.g. control signal OC1′ (1) through control signal OC1′ (12)) are at “Hi”, and control signal OC2 is at “Lo”. Thus, all scan ICs 55 are brought into “All-Lo” state, and the output terminals of all scan ICs 55 output reference potential A (0 (V) in this exemplary embodiment).

At time t9 thereafter, a predetermined constant current is input to input terminal IN2 of Miller integrating circuit 54 for generating a down-ramp voltage so that input terminal IN2 is set to “Hi”. With this operation, the drain voltage of switching element Q2 falls in a ramp form, the potential of reference potential A falls in a ramp form, and the output voltage of scan ICs 55 starts to fall in a ramp form.

Comparator CP1 compares the down-ramp voltage at reference potential A with voltage (Va+Vset3). Control signal OC2 output from comparator CP1 is changed from “Lo” to “Hi” at time t10 when the down-ramp voltage at reference potential A becomes equal to or lower than voltage (Va+Vset3). Thus, both control signals OC1′ (e.g. control signal OC1′ (1) through control signal OC1′ (12)) and control signal OC2 are at “Hi”, and all scan ICs 55 are brought into “All-Hi” state. Therefore, the voltage input to input terminals INb of scan ICs 55, i.e. voltage Vc where voltage Vscn is superimposed on reference potential A, is the output voltage of scan ICs 55. As a result, the down-ramp voltage to be applied to scan electrode SC1 through scan electrode SCn is down-ramp voltage L6 having a minimum voltage of voltage (Va+Vset3).

Next, time t11 after down-ramp voltage L6 has been generated, input terminal IN2 is set to “Lo”. In the above manner, scan electrode driving circuit 49 generates down-ramp voltage L6 and causes the second initializing discharge in the discharge cells applied with down-ramp voltage L5, before starting the address operation on scan electrodes 22 having undergone no address operation (e.g. scan electrode SCn/2+1 through scan electrode SCn).

Though not shown, at time t11, switching element Q5 is set to ON so that reference potential A is kept at negative voltage Va. Further, switching element SW1 and switching element SW2 are set to OFF, and switching element SW3 is set to ON so that voltage (Va+Vset4) is generated and reference potential A. i.e. negative voltage Va, is compared to voltage (Va+Vset4) in comparator CP1. Because the potential of reference potential A is lower than voltage (Va+Vset4) in this period, control signal OC2 output from comparator CP1 is at “Hi”.

At time t11, control signal OC1 is changed from “Hi” to “Lo”. Therefore, control signals OC1′ (e.g. control signal OC1′ (1) through control signal OC1′ (12)) output from AND gates AG (e.g. AND gate AG (1) through AND gate AG (12)) also become “Lo”. With this operation, all scan ICs 55 are brought into “DATA” state, where an address operation is started in response to scan start signals SIDs.

In the second address period, a scan pulse is sequentially applied to scan electrodes 22 having undergone no address operation yet (e.g. scan electrode SCn/2+1 through scan electrode SCn). For example, after the second initializing operation, scan IC (7), scan IC (8), scan IC (9), scan IC (10), scan IC (11), and scan IC (12) are caused to sequentially perform the address operation in this order. In this case, at time t12 immediately after the start of the second address period, scan start signal SID (7) is set to “Lo” for a predetermined period (e.g. one cycle of clock signal CLK). Then, scan IC (7) starts the address operation, and the scan pulse is sequentially applied to scan electrodes 22 connected to scan IC (7) (from scan electrode SCn/2+1 in this case).

Next, at a timing at which the address operation on all scan electrodes 22 connected to scan IC (7) is completed, scan start signal SID (8) is set to “Lo” for a predetermined period (e.g. one cycle of clock signal CLK). Then, scan IC (8) starts the address operation. Thereafter, similarly, scan start signal SID (9) through scan start signal SID (12) are set to “Lo” for a predetermined period. In this manner, the address operation is sequentially performed on scan IC (7) through scan IC (12) so that the scan pulse is applied to scan electrode SCn/2+1 through scan electrode SCn.

### (Sustain Period)

Next, at time t13 after the address operation on all scan electrodes 22 and the address period are completed, control signal OC1 is set to “Hi”. Because scan start signals SIDs (e.g. scan start signal SID (1) through scan start signal SID (12)) are kept at “Hi”, control signals OC1′ (e.g. control signal OC1′ (1) through control signal OC1′ (12)) output from AND gates AG are also at “Hi”.

Though not shown, at time t13, switching element Q5 is set to OFF, the clamp circuit of sustain pulse generating circuit 52 is operated, and reference potential A is set to 0 (V).

With this operation, the potential of reference potential A becomes higher than voltage (Va+Vset4), and thus control signal OC2 output from comparator CP1 is changed from “Hi” to “Lo” at time t13. That is, control signals OC1′ (e.g. control signal OC1′ (1) through control signal OC1′ (12)) are at “Hi”, and control signal OC2 is at “Lo”. Thus, all scan ICs 55 are brought into “All-Lo” state, where the output terminals of all scan ICs 55 output reference potential A (0 (V) in this exemplary embodiment).

Subsequently, though not detailed, the power recovery circuit and clamp circuit of sustain pulse generating circuit 52 are alternately operated to generate a predetermined number of sustain pulses. Then, at the end of the sustain period, erasing ramp voltage L3 is generated. In this manner, the sustain period is completed.

### (Initializing Period)

Though not shown, in the subsequent initializing period, while switching element Q5 is kept at OFF, switching element SW3 is set to ON so that voltage (Va+Vset4) is generated and reference potential A (0 (V) in this exemplary embodiment) is compared to voltage (Va+Vset4) in comparator CP1. Because reference potential A is higher than voltage (Va+Vset4), control signal OC2 output from comparator CP1 is still kept at “Lo” after the sustain period. Further, control signal OC1 is still kept at “Hi” after the sustain period.

Control signals OC1′ (e.g. control signal OC1′ (1) through control signal OC1′ (12)) are at “Hi”, and control signal OC2 is at “Lo”. Thus, all scan ICs 55 are still kept in All-Lo” state, and the output terminals of all scan ICs 55 output reference potential A, i.e. the driving voltage output from initializing waveform generating circuit 51 without change.

Next, at time t14, a predetermined constant current is input to input terminal IN2 of Miller integrating circuit 54 for generating a down-ramp voltage so that input terminal IN2 is set to “Hi”. With this operation, the drain voltage of switching element Q2 falls in a ramp form, the potential of reference potential A falls in a ramp form, and the output voltage of scan ICs 55 starts to fall in a ramp form.

At this time, control signals SIDs that control scan ICs 55 for outputting down-ramp voltage L4 are kept at “Hi”, similarly to generation of down-ramp voltage L2. For example, when scan IC (1) through scan IC (6) are caused to output down-ramp voltage L4, control signal SID (1) through control signal SID (6) are kept at “Hi”. Thus, control signal OC1′ (1) through control signal OC1′ (6) are kept at “Hi”.

In comparator CP1, the voltage of reference potential A, i.e. the down-ramp voltage, is compared to voltage (Va+Vset4). Control signal OC2 output from comparator CP1 changes from “Lo” to “Hi” at time t16 when the down-ramp voltage at reference potential A becomes equal to or lower than voltage (Va+Vset4).

Thus, both control signals OC1′ (e.g. control signal OC1′ (1) through control signal OC1′ (6)) that control scan ICs 55 for outputting down-ramp voltage L4 (e.g. scan IC (1) through scan IC (6)) and control signal OC2 are at “Hi” at time t16. Thus, scan ICs 55 for outputting down-ramp voltage L4 can be brought into “All-Hi” state. Therefore, at time t16, the voltage that is output from san ICs 55 for outputting down-ramp voltage L4 is equal to the voltage input to input terminal INb, i.e. voltage Vc where voltage Vscn is superimposed on reference potential A. As a result, the voltage drop switches to voltage rise at time t16. With this operation, down-ramp voltage L4 can be output from scan ICs 55 for outputting down-ramp voltage L4. For example, down-ramp voltage L4 having a minimum voltage of voltage (Va+Vset4) can be applied to scan electrode SC1 through scan electrode SCn/2.

On the other hand, control signals SIDs that control scan ICs 55 for outputting down-ramp voltage L7 are changed from “Hi” to “Lo” before time t14, similarly to generation of down-ramp voltage L5. For example, when scan IC (7) through scan IC (12) are caused to output down-ramp voltage L7, control signal SID (7) through control signal SID (12) are changed from “Hi” to “Lo” before time t14. Thus, from OR gate OR (7) through OR gate OR (12), signal CPO output from comparator CP2 is output. From AND gate AG (7) through AND gate AG (12), signal CPO is output as control signal OC1′ (7) through control signal OC1′ (12).

Because comparator CP2 compares reference potential A with voltage (Va+Vset5), signal CPO output from comparator CP2 changes from “Hi” to “Lo” at time t15 when reference potential A becomes equal to or lower than voltage (Va+Vset5).

With this operation, at time t15, control signals OC1′ (e.g. control signal OC1′ (7) through control signal OC1′ (12)) that control scan ICs 55 for outputting down-ramp voltage L7 (e.g. scan IC (7) through scan IC (12)) can be changed from “Hi” to “Lo”.

That is, both control signals OC1′ that control scan ICs 55 for outputting down-ramp voltage L7 and control signal OC2 are at “Lo” at time t15. Thus, scan ICs 55 for outputting down-ramp voltage L7 can be brought into “HiZ” state. Therefore, the output voltage of scan ICs 55 for outputting down-ramp voltage L7 is a voltage where the output voltage at time t15 is maintained. For example, down-ramp voltage L7 having a minimum voltage of voltage (Va+Vset5) can be applied to scan electrode SCn/2+1 through scan electrode SCn.

Then, at time t17 before the completion of the initializing period, 0 (V), for example, is applied to input terminal IN2 so as to set input terminal IN2 to “Lo”.

In the above manner, in scan electrode driving circuit 49, down-ramp voltage L4, which falls from voltage Vi3 toward voltage (Va+Vset4), is output from scan ICs 55 for outputting down-ramp voltage L4 (e.g. scan IC (1) through scan IC (6)). Thereby, down-ramp voltage L4 is applied to scan electrodes 22 that are to undergo the address operation in the period from the first initializing operation to the second initializing operation (e.g. scan electrode SC1 through scan electrode SCn/2).

On the other hand, down-ramp voltage L7, which falls from voltage Vi3 toward voltage (Va+Vset5), is output from scan ICs 55 for outputting down-ramp voltage L7 (e.g. scan IC (7) through scan IC (12)). Thereby, down-ramp voltage L7 is applied to scan electrodes 22 that are to undergo the address operation after the second initializing operation (e.g. scan electrode SCn/2+1 through scan electrode SCn). In this manner, the initializing period is completed.

The operations in the subsequent address period, sustain period, and thereafter are similar to those described above.

The above timing chart merely shows an example of the operation. In this exemplary embodiment, the order of the address operations of scan ICs 55 in the address period is changed according to the detected partial light-emitting rates. Thus, according to the change, scan ICs 55 for outputting down-ramp voltage L2 (or down-ramp voltage L4) and scan ICs 55 for outputting down-ramp voltage L5 (or down-ramp voltage L7) are changed.

In the example of FIG. 20, after the first initializing operation, the address operation is performed on region (1), region (3), region (5), region (7), region (9), and region (11) in this order. Then, after the subsequent second initializing operation, the address operation is performed on region (2), region (4), region (6), region (8), region (10), and region (12) in this order. For this purpose, in the initializing periods, down-ramp voltage L2 (or down-ramp voltage L4) is applied to scan IC (1), scan IC (3), scan IC (5), scan IC (7), scan IC (9), and scan IC (11). Down-ramp voltage L5 (or down-ramp voltage L7) is applied to scan IC (2), scan IC (4), scan IC (6), scan IC (8), scan IC (10), and scan IC (12). In order to set the down-ramp voltage to be applied to scan IC (1), scan IC (3), scan IC (5), scan IC (7), scan IC (9), and scan IC (11) to down-ramp voltage L2 (or down-ramp voltage L4), scan start signal SID (1), scan start signal SID (3), scan start signal SID (5), scan start signal SID (7), scan start signal SID (9), and scan start signal SID (11) are kept at “Hi” in the initializing periods. In order to set the down-ramp voltage to be applied to scan IC (2), scan IC (4), scan IC (6), scan IC (8), scan IC (10), and scan IC (12) to down-ramp voltage L5 (or down-ramp voltage L7), scan start signal SID (2), scan start signal SID (4), scan start signal SID (6), scan start signal SID (8), scan start signal SID (10), and scan start signal SID (12) are changed from “Hi” to “Lo” before time t3 (or before time t14).

Further, in the first address periods, scan start signals SIDs are generated so that scan IC (1), scan IC (3), scan IC (5), scan IC (7), scan IC (9), and scan IC (11) perform the address operation in this order. In the second address period after the second initializing operation, scan start signals SIDs are generated so that scan IC (2), scan IC (4), scan IC (6), scan IC (8), scan IC (10), and scan IC (12) perform the address operation in this order.

As described above, in this exemplary embodiment, performing a plurality of initializing operations can increase the number of regions where the lapse of time from the initializing operation to the address operation can be shortened, and allows the address operation on the regions having the higher partial light-emitting rates in the shorter lapse of time from the initializing operation to the address operation. Thus, even in a panel of large screen and high luminance and high definition, this structure can prevent an increase in the scan pulse voltage (amplitude) necessary for causing a stable address discharge, thereby causing a stable address discharge.

In the present invention, the structure of the second exemplary embodiment and the structure of the third exemplary embodiment can be combined. In one of subfields where the rate of the luminance weight in one field is equal to or higher than a predetermined rate, or the number of sustain pulses generated in the sustain period is equal to or larger than a predetermined number, the operation in the third exemplary embodiment is performed. That is, a plurality of initializing operations are performed and the address operation is performed on the respective regions in the order such that the lapse of time from the initializing operation to the address operation is shorter in the regions having the higher partial light-emitting rates. In contrast, in one of the subfields where the rate of the luminance weight in one field is lower than the predetermined rate, or the number of sustain pulses generated in the sustain period is smaller than the predetermined number, the address operation is performed in a predetermined order as described in the second exemplary embodiment. Such a structure can smooth the luminance change based on the address discharge on the image display surface of panel 10, and enhance the image display quality.

The exemplary embodiments of the present invention are also effective in a panel having an electrode array where scan electrode 22 is adjacent to scan electrode 22 and sustain electrode 23 is adjacent to sustain electrode 23. In the electrode array, the electrodes are arranged on front plate 21 in the following order: scan electrode 22, scan electrode 22, sustain electrode 23, sustain electrode 23, scan electrode 22, scan electrode 22, or the like.

In the structure described in the exemplary embodiments of the present invention, erasing ramp voltage L3 is applied to scan electrode SC1 through scan electrode SCn. However, erasing ramp voltage L3 may be applied to sustain electrode SU1 through sustain electrode SUn. Alternatively, instead of erasing ramp voltage L3, a so-called narrow erasing pulse may be used to cause an erasing discharge.

The specific numerical values in the exemplary embodiments of the present invention are based on the characteristics of 50-inch diagonal panel 10 having 1080 display electrode pairs 24, and merely show examples in the exemplary embodiments. The present invention is not limited to these numerical values. Preferably, numerical values are set optimum for the characteristics of panel 10, the specifications of plasma display device 1, or the like. For each of these numerical values, variations are allowed within the range in which the above advantages can be offered. Further, the number of subfields, the luminance weights of the respective subfields, or the like is not limited to the values shown in the exemplary embodiments of the present invention. The subfield structure may be switched according to image signals, for example.

### INDUSTRIAL APPLICABILITY

The present invention can cause a stable address discharge by preventing an increase in the scan pulse voltage (amplitude) necessary for causing a stable address discharge, and thus enhance the image display quality, even in a panel of large screen and high definition. Thus, the present invention is useful as a plasma display device and a driving method for a panel.

### REFERENCE SIGNS LIST

1, 2 Plasma display device
10 Panel
21 Front plate
22 Scan electrode
23 Sustain electrode
24 Display electrode pair
25, 33 Dielectric layer
26 Protective layer
31 Rear plate
32 Data electrode
34 Barrier rib
35 Phosphor layer
41 Image signal processing circuit
42 Data electrode driving circuit
43, 49 Scan electrode driving circuit
44 Sustain electrode driving circuit
45, 46 Timing generating circuit
47 Partial light-emitting rate detecting circuit
48 Light-emitting rate comparing circuit
50, 56 Scan pulse generating circuit
51 Initializing waveform generating circuit
52 Sustain pulse generating circuit
53, 54 Miller integrating circuit
55 Scan IC
60 Scan IC switching circuit
61 SID generating circuit
62, 65 FF (flip-flop circuit)
63 Delay circuit
64, 66 AND gate
72 Switch
CP1, CP2 Comparator
Q1, Q2, Q4, Q5, QH1 through QHn, QL1 through QLn, SW1, SW2, SW3 Switching element
R1, R2 Resistor
C1, C2, C31 Capacitor
D31 Diode
OR OR gate
AG AND gate

1. A plasma display device comprising:
a plasma display panel,
the plasma display panel being driven by a subfield method in which a plurality of subfields are set in one field, each of the subfields has an initializing period, an address period, and a sustain period, a luminance weight is set for each subfield, and sustain pulses corresponding in number to the luminance weight are generated in the sustain period for gradation display,
the plasma display panel having a plurality of discharge cells, the discharge cells having display electrode pairs, each of the display electrode pairs being formed of a scan electrode and a sustain electrode;
a scan electrode driving circuit for performing an address operation by applying a scan pulse to the scan electrodes in the address period; and
a partial light-emitting rate detecting circuit for dividing a display area of the plasma display panel into a plurality of regions, and for detecting a rate of the number of discharge cells to be lit with respect to the number of all the discharge cells in each of the regions, as a partial light-emitting rate, in each subfield,
wherein the scan electrode driving circuit performs a first initializing operation in the initializing period, and performs a second initializing operation in the address period, and
the scan electrode driving circuit performs the address operation on the region having the highest partial light-emitting rate detected in the partial light-emitting rate detecting circuit, immediately after the first initializing operation, and performs the address operation on the region having the second highest partial light-emitting rate immediately after the second initializing operation.

2. A plasma display device comprising:
a plasma display panel,
the plasma display panel being driven by a subfield method in which a plurality of subfields are set in one field, each of the subfields has an initializing period, an address period, and a sustain period, a luminance weight is set for each subfield, and sustain pulses corresponding in number to the luminance weight are generated in the sustain period for gradation display,
the plasma display panel having a plurality of discharge cells, the discharge cells having display electrode pairs, each of the display electrode pairs being formed of a scan electrode and a sustain electrode;
a scan electrode driving circuit for performing an address operation by applying a scan pulse to the scan electrodes in the address period; and
a partial light-emitting rate detecting circuit for dividing a display area of the plasma display panel into a plurality of regions, and for detecting a rate of the number of discharge cells to be lit with respect to the number of all the discharge cells in each of the regions, as a partial light-emitting rate, in each subfield,
wherein the scan electrode driving circuit performs a first initializing operation in the initializing period, and performs a second initializing operation in the address period, and
the scan electrode driving circuit performs the address operation on the region having the highest partial light-emitting rate detected in the partial light-emitting rate detecting circuit, immediately after the second initializing operation, and performs the address operation on the region having the second highest partial light-emitting rate immediately after the first initializing operation.

3. The plasma display device of claim 1, wherein the scan electrode driving circuit performs the address operation on the regions that have at most the third highest partial light-emitting rate detected in the partial light-emitting rate detecting circuit, in an order such that a lapse of time from the initializing operation to the address operation is shorter in the regions having the higher partial light-emitting rates.

4. The plasma display device of claim 1, wherein
the scan electrode driving circuit has a plurality of scan integrated circuits (ICs) capable of performing the address operation on the plurality of scan electrodes, and
the partial light-emitting rate detecting circuit sets an area that is formed of the plurality of scan electrodes connected to one of the scan ICs, as one of the regions.

5. A driving method for a plasma display panel,
the plasma display panel having a plurality of discharge cells, the discharge cells having display electrode pairs, each of the display electrode pairs being formed of a scan electrode and a sustain electrode,
the plasma display panel being driven by a subfield method in which a plurality of subfields are set in one field, each of the subfields has an initializing period, an address period, and a sustain period, a luminance weight is set for each subfield, a scan pulse is applied to the scan electrodes the address period for an address operation, and sustain pulses corresponding in number to the luminance weight are generated in the sustain period for gradation display,
the driving method comprising:
performing a first initializing operation in the initializing period, and performing a second initializing operation in the address period;
dividing a display area of the plasma display panel into a plurality of regions, and detecting a rate of the number of discharge cells to be lit with respect to the number of all the discharge cells in each of the regions, as a partial light-emitting rate, in each subfield; and
performing the address operation on the region having the highest partial light-emitting rate detected, immediately after the first initializing operation, and performing the address operation on the region having the second highest partial light-emitting rate immediately after the second initializing operation.

6. A driving method for a plasma display panel,
the plasma display panel having a plurality of discharge cells, the discharge cells having display electrode pairs, each of the display electrode pairs being formed of a scan electrode and a sustain electrode,
the plasma display panel being driven by a subfield method in which a plurality of subfields are set in one field, each of the subfields has an initializing period, an address period, and a sustain period, a luminance weight is set for each subfield, a scan pulse is applied to the scan electrodes in the address period for an address operation, and sustain pulses corresponding in number to the luminance weight are generated in the sustain period for gradation display,
the driving method comprising:
performing a first initializing operation in the initializing period, and performing a second initializing operation in the address period;
dividing a display area of the plasma display panel into a plurality of regions, and detecting a rate of the number of discharge cells to be lit with respect to the number of all the discharge cells in each of the regions, as a partial light-emitting rate, in each subfield; and
performing the address operation on the region having the highest partial light-emitting rate detected, immediately after the second initializing operation, and performing the address operation on the region having the second highest partial light-emitting rate immediately after the first initializing operation.

7. The plasma display device of claim 2, wherein the scan electrode driving circuit performs the address operation on the regions that have at most the third highest partial light-emitting rate detected in the partial light-emitting rate detecting circuit, in an order such that a lapse of time from the initializing operation to the address operation is shorter in the regions having the higher partial light-emitting rates.

8. The plasma display device of claim 2, wherein
the scan electrode driving circuit has a plurality of scan integrated circuits (ICs) capable of performing the address operation on the plurality of scan electrodes, and
the partial light-emitting rate detecting circuit sets an area that is formed of the plurality of scan electrodes connected to one of the scan ICs, as one of the regions.
